(19) United States
(12) Patent Application Publication
(10) Pub. No.: US 2023/0142672 A1
(43) Pub. Date: May 11, 2023

(54) PASSIVATION OF FILTER RESIDUES

(71) Applicant: EOS GmbH Electro Optical Systems, Krailling (DE)

(72) Inventors: Ulrich Kleinhans, Prittriching (DE); Sven Pawliczek, Gilching (DE); Christoph Schmutzler, Augsburg (DE); Philip Stroebel, Weidenbach (DE); Sebastian Mehl, Puchheim (DE); Peter Hofbauer, Muenchen (DE); Marbod Kindermann, Muenchen (DE)

(73) Assignee: EOS GmbH Electro Optical Systems, Krailling (DE)

(21) Appl. No.: 17/795,283

(22) PCT Filed: Jan. 27, 2021
(86) PCT No.: PCT/EP2021/051853

§ 371 Date: Jul. 26, 2022

(30) Foreign Application Priority Data
Jan. 27, 2020 (DE) 10 2020 000 501.2

(51) Int. Cl. B22F 1/145; B01D 46/00; B01F 27/72; B33Y 40/00

(52) U.S. Cl. CPC B22F 1/145; B01D 46/0093; B01F 27/72; B33Y 40/00; B22F 1/054

(57) ABSTRACT

A passivation device for passivating filter residues of a filter device arranged in a process gas circuit of an additive manufacturing apparatus includes a reaction unit having an inlet suitable for supplying an oxidant, a coupling unit adapted to be coupled to the filter device for introducing filter residues into the reaction unit, a discharge unit suitable for discharging passivated filter residues from the reaction unit, and an energy supply unit suitable for effecting a reaction between the filter residues and the oxidant in the reaction unit.

The present invention relates to a method and a device for passivating filter residues of a filter device arranged in a process gas stream of a device for additive manufacturing of three-dimensional objects.

Devices and methods for additive manufacturing of three-dimensional objects are used, for example, in rapid prototyping, rapid tooling or additive manufacturing. An example of such a process is known as “selective laser sintering or laser melting”. In this process, a layer of a building material, usually in powder form, is repeatedly applied and the building material is selectively solidified in each layer by selectively irradiating locations corresponding to the cross-section of the object to be produced in this layer with a laser beam. Further details are described, for example, in EP 2 978 589 B1.

During the manufacturing process, a process gas atmosphere, usually an inert gas atmosphere, is often maintained in the process chamber in which the building material is selectively melted by radiation. The reason is that some building materials, especially if they contain metals, tend to oxidize at the high temperatures during the melting process, which prevents the formation of objects or at least prevents the formation of objects with a desired material structure. As a rule, in doing so, a process gas stream is passed across the building plane, i.e. the surface of a building material layer to be solidified.

However, since during the process, i.e. the irradiation of the building material, building material evaporates on the one hand and building material is whirled up on the other hand, it is necessary to free the process gas from these undesirable additives, usually condensate particles with a size below 50 nm or pulverulent building material with particle sizes between 1 and 50 μm. In US 2014/0287080, a closed gas flow circuit is provided for this purpose, by means of which a gas flow is passed through the build chamber of a selective laser melting device, wherein two filter devices are arranged in the gas flow circuit, each having a filter element.

DE 10 2014 207 160 A1 describes a cyclic cleaning of a filter element of a recirculation air filter device by means of a gas pressure surge.

In particular when using metal-containing or metallic building materials (e.g. titanium or titanium alloys), the particles tend to react with oxidative materials at high temperatures, with the reaction rate being increased at high temperatures. This can lead to uncontrolled filter blazes or dust explosions, especially in the area of filter elements where the particles carried along in the process gas accumulate. This risk is increased if oxygen reaches the filter element during a change of the filter element.

EP 1 527 807 proposes inerting for separating dust components from an explosive dust-air mixture by using additive particles with which filter plates are loaded. In doing so, the amount of additive particles is selected so that the mixture of these particles with an introduced dust does not constitute a combustible mixture at least until an upper filling level of a dust container is reached. Particles of calcium carbonate and silicon dioxide are mentioned as additive particles in connection with aluminum dust. However, by using additional particles, in addition to providing them, a faster reaching of the upper filling level is accepted, so that the dust container must be emptied more often.

The object of the present invention is to provide an alternative or improved method and an alternative or improved device for preventing dust explosions, in particular in connection with additive manufacturing devices.

This object is solved by a passivation device according to claim 1, a use of a passivation device according to claim 10, and a method according to claim 11. Further developments of the invention are given in the dependent claims each. In this context, the method can also be further developed by the features of the devices described below or in the dependent claims, and vice versa, and the features of the devices can also each be used among one another for further development.

A passivation device according to the invention for passivating filter residues of a filter device arranged in a process gas circuit of an additive manufacturing apparatus comprises:
a reaction unit having:
an inlet suitable for supplying an oxidant,
a coupling unit adapted to be coupled to the filter device for introducing the filter residues into the reaction unit,
a discharge unit suitable for discharging passivated filter residues from the reaction unit, and
an energy supply unit suitable for effecting a reaction between the filter residues and the oxidant in the reaction unit.

Filter residues in a filter element of the filter device in this case can be condensate particles from building material evaporated and recondensed in the process, powder particles of the building material, or else inerting substances in the filter device. The latter are, for example, powdered minerals in the order of magnitude of 1 to 20 μm, which are intended to spatially separate the hazardous condensate particles from one another and are to serve as a thermal ballast. Condensate particles usually result from laser welding fumes consisting of agglomerated nanoparticles, with the primary particles being in the order of 5-50 nm. The condensate particles remaining in the filter element as filter residues are often agglomerated to form so-called filter cakes several millimeters in size, which, however, rapidly disintegrate on contact. Building material in powder form typically exhibits particle sizes (d50) between 25 and 35 μm, typically 30 μm.

The present invention is preferably applied in connection with metal-containing building materials, in particular metal powders such as titanium or aluminum powders or titanium, iron, nickel or aluminum alloy powders, where metal condensate particles remain as filter residue.

A coupling unit can be implemented, for example, in the form of a valve, a flap, a slider or a (gas) lock, and should in particular be capable of preventing particles from the filter device from entering the passivation device. In particular, the coupling unit should be able to be coupled to a particle collection area in the filter device, in which the particles filtered out of the process gas stream accumulate as filter residues, for example after a cleaning process of the filter element. Since particles fall downwards due to gravity, a particle collection area is usually arranged in the lower area of the filter device and, accordingly, the coupling unit is preferably coupled to the lower end of the filter device. The term “able to be coupled” is meant here to include both coupling units that can be coupled to and uncoupled from a filter device, and coupling units that cannot be removed from the filter device, i.e., are in permanent connection with the filter device.

In doing so, the filter device should preferably be a recirculation air filter device that is operated in a closed process gas circuit. Optionally, the condensate particles that are preferably to be passivated can be separated from the remaining particles before the passivation treatment, for example by means of screening or by means of a cyclone.

The reaction unit in its simplest embodiment has a reaction space in which passivation of filter residues, in particular controlled oxidation of condensate particles, is possible, preferably with isolation from the environment.

Preferably, the material to be passivated is supplied to the reaction chamber from above, i.e., through an opening in the upper region of the reaction chamber, since gravity can then be utilized to transport the material into the reaction chamber. The coupling unit is thus preferably connected to the upper side of the reaction chamber.

Further preferably, at the exit of the filter device, in the coupling unit or at the upper side of the reaction chamber, a trickle promoting device can be provided, by which is meant, for example, a vibrating device or a device which supplies gas intermittently to the condensate material in order to promote the movement of the condensate material and to counteract adhesion of the condensate material to walls or of condensate particles to one another. By means of the vibrating device, for example, the wall of an outlet funnel of the filter device, the wall of an inlet funnel of the reaction chamber or one or several walls in the coupling unit can be set in vibration. For the intermittent supply of gas, for example, the wall of an outlet funnel of the filter device, the wall of an inlet funnel of the reaction chamber or one or several walls in the coupling unit can be penetrated by holes, in particular fluidizing plates can be attached at these locations.

Preferably, the discharge unit is provided at the lower end of the reaction chamber, since gravity can then be utilized to transport the material out of the reaction chamber.

An inlet suitable for supplying an oxidant can comprise a supply pipe and is preferably suitable for supplying a preheated gas, thus has a corresponding temperature resistance. Oxygen is preferably used as the oxidant.

An energy supply unit is in particular suitable for supplying the energy required to start (initiate) a reaction between the filter residues and the oxidant or to maintain and/or intensify or accelerate a reaction between the filter residues and the oxidant. Preferably, the energy supplied is selected to be only high enough to prevent connecting (a mutual adhesion or fusion) of the condensate particles. In other words, preferably the energy supplied by the energy supply unit for a passivation (e.g., a controlled oxidation) is adapted to the type and nature of the condensate particles.

In the present invention, passivation of hazardous condensate particles, in particular metal condensates, can be provided by processing particles that have already been filtered out of a process gas circuit so that the passivation does not affect the process gas circuit, in particular the process gas flow through the additive manufacturing device. Furthermore, by removing the filter residues as soon as possible, the filter cleaning intervals or the filter replacement intervals can be extended. Looking at it the other way round, the entire amount of filter residues accruing during a cleaning process by means of pressure surge could also be introduced into the passivation device, which would lead to a preference for short filter cleaning intervals.

Preferably, the coupling unit comprises a portioning unit for limiting the amount of filter residues supplied to the reaction unit to a predefined value.

A portioning unit can be implemented, for example, by means of pre-dimensioned blades or, in the simplest embodiment, by means of an inclined plane or a funnel of defined slope, which lead to a delayed transport of the particulate material and thus limit the amount of filter residues supplied to the reaction unit.

Furthermore, the portioning unit can include a load cell or light barrier/photodiode to determine the amount of filter residues. In other words, limiting the amount can consist in limiting the volume or weight of filter residues supplied.

A flow amount or mass flow or volume flow can preferably be controlled by controlling the time period of the flow (“valve open” vs. “valve closed”) and/or the flow rate (mass/volume per time; open cross-section of the valve). Further, the portioning unit can include a closure (slotted shutter, iris diaphragm, flat slide gate, swing gate, rotary valve, chamber lock, a segmental closure) or the like.

The presence of a portioning unit facilitates controlled oxidation of condensate particles, since the limited amount of condensate particles produced in each case ensures that the heat generated during oxidation and thus uncontrolled heating of the reaction chamber or uncontrolled reaction of the metal condensates are prevented/limited.

Further preferably, the coupling unit and/or the discharge unit are designed to be able to close the reaction unit in a gas-tight manner.

The gas-tight sealability enables the oxidation of the filter residues to be carried out under a controlled gas atmosphere. In particular, by a gas-tight closure of the coupling unit, the gas atmosphere containing an oxidant is separated from the process gas atmosphere, so that contamination of the process gas atmosphere with oxidant is avoided and, in particular, the process gas circuit is not affected by the passivation operations. In other words, use of the passivation device is advantageous especially for recirculation air filter devices, since the recirculating air operation is not disturbed or need to be interrupted.

Further preferably, the coupling unit and/or the discharge unit are designed to resist a pressure difference of up to 8 bar, preferably up to 15 bar, in the closed state.

Thus, the pressure within the reaction unit is allowed to fluctuate with respect to the pressure in the filter device (in the case of the coupling unit) or the pressure in the collection container (in the case of the discharge unit). This facilitates the implementation of a controlled passivation/oxidation by allowing more freedom for the guidance of the reaction.

Although preferably an attempt is made to prevent a pressure increase in the reaction unit by a controlled and limited oxidant addition, for safety reasons the coupling unit and/or the discharge unit should be able to resist a pressure difference of up to 15 bar (occurring explosion pressure in the case of microdusts), but at least up to 8 bar (occurring explosion pressure in the case of nanodusts).

Further preferably, the reaction unit comprises a reaction chamber, in the wall of which a pressure compensation valve is arranged.

By means of the reaction chamber, a, preferably closed, reaction space is provided for oxidation of filter residues, which enables better control of the reaction process. By means of the pressure compensation valve, it can be ensured that the pressure inside the reaction unit is not subjected to excessive fluctuations that could lead to destruction of the reaction unit. The pressure compensation valve preferably provides a connection between the interior of the reaction chamber and an inert gas reservoir. In some circumstances, a connection can also be established with the ambient atmosphere, but this can be fraught with risk due to the presence of oxygen in the ambient atmosphere.

For example, the material and thickness of the wall of the reaction chamber can be selected so that the wall has a large heat capacity and thus does not heat up too much due to the oxidation processes taking place inside the reaction chamber. For example, steel can be selected as the material for the wall and the wall thickness can then be set to about 1 cm.

Further preferably, the wall of the reaction chamber is designed to resist a pressure difference of up to 8 bar, preferably up to 15 bar.

In other words, the reaction chamber should preferably have a certain pressure resistance so that large pressure variations in the reaction chamber, which can occur at rapid oxidation processes, do not lead to destruction of the reaction chamber. In particular, other existing closures of entrances or exits to the reaction chamber should also have the specified pressure resistance in the closed state.

Although preferably an attempt is made to prevent an increase in pressure in the reaction chamber by a controlled and limited addition of the oxidant, for safety reasons the walls of the reaction chamber should be able to resist a pressure difference of up to 15 bar (occurring explosion pressure in the case of microdusts), but at least up to 8 bar (occurring explosion pressure in the case of nanodusts).

Further preferably, a conveying device for transporting away the passivated filter residues is attached to the discharge unit.

By actively transporting away the passivated filter residues, it is possible to ensure a more rapid passivation process, since it is not necessary to rely solely on the effect of gravity to discharge the passivated filter residues from the reaction chamber. In particular, this also makes it possible to arrange the collection container at some distance from the passivation device, since the spatial distance can then be bridged by the conveying device.

Further preferably, the conveying device comprises a screw, in particular an extruder screw.

The conveying screw can have a varying cross-section or outer diameter, which changes monotonically (increases or decreases) along the direction of extension of the screw towards the collection container. Alternatively or additionally, the pitch of the screw can also vary. Furthermore, the screw can be supplemented by additional mixing elements.

By using a conveying device suitable for compressing the passivated filter residues, the passivated filter residues can be stored in the collection container in a space-saving manner, so that the container does not need to be emptied so often. An extruder screw is particularly suitable as a conveying device. In the case of an extruder screw, the desired compression can be achieved by the depth of a flight having a smaller value at a location further away from the discharge unit than at a location closer to the discharge unit.

Further preferably, the reaction unit is an extruder screw or conveying screw.

In this embodiment of the invention, the reaction space for oxidation of the filter residues is the space between the thread flights of the screw thread. In other words, the oxidant, for example a gas containing an oxidant, is transported to the screw via the inlet so that the reaction can take place while the filter residues are being transported. Again, the gas can have been brought to an elevated temperature prior to introduction to promote the progression of the oxidation reaction. As a result of using an extruder screw, the filter residues can also be compressed at the same time so that the passivated filter residues can be stored in the collection container in a space-saving manner.

Further preferably, a direction of rotation of the extruder screw or conveying screw can be switched.

By changing the direction of rotation of the screw, the filter residues can be displaced relative to one another, which facilitates the access of the oxidant to the filter residues, in particular in the case of a plurality of changes of the direction of rotation.

Further preferably, the energy supply unit on the extruder screw comprises a heating element (e.g., a jacket heating or a heating on the gas supply/oxidant supply (at the inlet).

Further preferably, the conveying screw can be designed as a reaction chamber and can comprise a cylindrical screw core surrounded by a screw helix, and a screw tube as a wall of the reaction chamber.

Since the passivation of the filter residues or of the condensate material takes place in a reaction chamber enclosing a reaction space, the conveying screw is thus to be regarded as the reaction chamber. Here, the screw helix extends in the radial direction between the preferably circular-cylindrical screw core and the inner edge of the screw tube, which is preferably spaced from the outer radial edge of the screw helix only to such an extent that rotation of the screw core and screw helix around the cylinder axis of the screw core is not impeded by the screw tube and/or filter residues accumulating in the gap between the screw helix and screw tube.

Preferably, the screw core and/or the screw helix and/or the screw tube are produced by means of an additive manufacturing process, wherein the screw core and/or the screw helix and/or the screw tube can be manufactured not necessarily as a whole, but also in parts. After their manufacture, the parts can then be connected to one another in a force-locking and/or form-locking manner, for example by being screwed or latched together. In particular, elements of the screw helix can be slipped onto the screw core after their manufacture.

Further preferably, geometric dimensions of the conveying screw, in particular a depth of a flight, a pitch of a flight, a shape of the flanks of the screw helix or a flank angle of the screw helix, can vary along the cylinder axis of the screw core.

The term “varying geometric dimension” refers in particular to a radial dimension of the screw core or to the core diameter, i.e., an outer diameter of the cylinder at a location on the cylinder axis. Likewise, however, it can also refer to a shape (form) of the turns of the screw helix. As in the case of a thread of a screw, one can describe a shape (form) of the turns of the screw helix by means of a flank profile, i.e., for example, speak of a flat profile, round profile, saw profile or a pointed thread or trapezoidal thread. Furthermore, the term is also intended to refer to notches or recesses (triangular, rectangular or trapezoidal, etc.) provided in some places in the screw helix.

The depth of a flight is defined here as the difference between the thread outer diameter (i.e. the radial outer diameter of the screw helix) and the thread inner diameter (i.e. the radial outer diameter of the cylindrical screw core). The pitch of a flight is defined here as the distance along the cylinder axis covered when a 360° revolution around the cylinder axis has been completed during a movement along the outer edge of the helical screw helix. If the flight pitch is varied, then the degree of filling of the screw can be changed locally, for example by reducing the flight pitch in the region of an oxidation zone, so that the gas content (volume-related) is increased and oxidation is thus facilitated.

The term “flank angle” has the same meaning known to those skilled in the art in connection with screw threads.

Further preferably, the conveying screw can comprise at least one compression zone and at least one oxidation zone, wherein the depth of the flight in the at least one compression zone is smaller than in the at least one oxidation zone.

The compression zone and the oxidation zone are regions that extend in the direction of the cylinder axis of the screw core. In a compression zone, the condensate material is compressed, in particular its bulk density is increased. In an oxidation zone, the lower density or bulk density provides for better access of the oxidant to the condensate particles. If the condensate is conveyed in compressed form from the compression zone to the oxidation zone, the relatively larger cavity there offers the possibility that the condensate loosens as a result of the penetration of the gas entering the cavity, wherein it is aimed at loosening up or reducing the bulk density of the condensate as homogeneously as possible in view of an oxidation as homogeneous as possible.

There are standards for determining the bulk density (e.g. ASTM D 7481), although in the present context it is not so much the absolute values of the bulk density that are important, but rather relative changes.

A location of the compression zone close to the entry of the screw, where the coupling unit is coupled, is advantageous from the point of view that the compacted condensate material then constitutes a barrier for the oxidant to overcome, so that it cannot easily reach the filter device. A position close to the discharge unit has the advantage that this can increase the standing time of the collection container, since the material is thereby deposited in it in a more compacted form. It is particularly advantageous to provide a compression zone both near the entry of the screw and near the outlet region. In this case, an oxidation zone can be located between the two compression zones.

Further preferably, the conveying screw can comprise more than one oxidation zone.

The presence of a plurality of oxidation zones allows to carry out a multi-stage passivation or oxidation of the filter residues in the conveying screw. Thus, the passivation can be carried out more gently, for example, by increasing an oxidant content of a supplied gas amount or an amount of supplied oxidant with each oxidation zone located downstream in the conveying direction.

Further preferably, the conveying screw can comprise at least one mixing zone along the cylinder axis of the screw core, in which a section of the conveying screw is designed as a mixing element along the cylinder axis.

In the mixing zone, the filter residues introduced into the conveying screw are moved mechanically. For this purpose, a section of the screw helix can, for example, have the shape of a shear mixing element, in particular a spiral mixing element as known in the prior art. In a spiral mixing element, the narrow gaps between adjacent spiral ridges result in a high shearing of the material, whereby agglomerates can be broken up (dispersive mixing) and thus, during subsequent oxidation/passivation, the possibility of access of the oxidant to the surfaces of the particles of the filter residues can be improved.

If the section of the screw helix is designed as a toothed disc mixing element or diamond mixing element, then this can achieve an increase in surface area and a rearrangement of particles (distributive mixing). Of course, intermediate forms between the above models are also conceivable in the design of the mixing element. It is understood that the diameter of the screw core along the section may differ from the diameter of the screw core in other regions of the screw.

Furthermore, a mixing zone can also be realized by arranging projections along a section of the conveying screw on the inner side of the screw tube and by perforating the screw helix at the locations of the projections to allow unobstructed movement of the screw helix.

Preferably, the mixing zone is arranged close to or at the entry of the conveying screw, i.e. where the filter residues enter the conveying screw. However, several mixing zones can also be provided, for example also at those locations along the longitudinal axis of the screw where oxidant is supplied.

Further preferably, the inlet is arranged at an oxidation zone near that one of the two ends of the oxidation zone that is closer to the coupling unit.

The oxidant supplied via the inlet is preferably supplied as a component of a supplied gas. Supplying in pure form is possible if the oxidant is a weak oxidant. Under certain circumstances, supplying in liquid form would also be possible, for example by means of a spray nozzle integrated into the inlet. A supply of the oxidant is particularly useful in those areas of the route that are provided as oxidation zones. A supply near that one of the two ends of the oxidation zone which is closer to the coupling unit has the advantage that a reaction of the condensate material with the oxidant can then take place during the entire period of time in which the condensate material is conveyed through the oxidation zone. Preferably, the intended reaction time is greater than or equal to 5 min and/or less than or equal to 10 min. The reaction time is usefully selected as a function of the temperature in the reaction space, the partial pressure of the oxidant, and the accessibility of the passivated material (can this be easily removed?).

Further preferably, a plurality of inlets can be provided.

It is possible, for example, to provide a plurality of inlets along the circumferential direction of the screw or screw tube, e.g. at constant distances from each other, i.e. regularly distributed along the circumference, although different positions in the direction of the cylinder axis of the screw core being also possible. In this way, the oxidant can be suplied to the condensate material as uniformly as possible to ensure the most homogeneous passivation possible.

Regardless of the number of inlets, an arrangement of an inlet at the lower end (with respect to the vertical) of the screw tube has the advantage that the condensate is then swirled up by a supplied gas, allowing better access of the oxidant to the condensate particles. Of course, an inlet can also be provided at the upper end (with respect to the vertical) of the screw tube. In particular, but not only in this case, it can be advantageous to select the cross-section of the inlet to be small (e.g., between 3 and 5 mm), thereby increasing the velocity of a supplied gas and providing for more uniform access of the oxidant to the condensate material.

Further preferably, at least one inlet can be arranged at each oxidation zone that is present.

If each oxidation zone is provided with an inlet of its own, then different amounts of oxidant can be supplied to the different oxidation zones, allowing, for example, for multi-stage oxidation with stepwise increase of oxidant addition.

Further preferably, the inlet has a cylinder shape (cylinder definition in the mathematical sense), with the longitudinal axis of the cylinder having an angle different from 90° with respect to the wall of the screw tube. The inclination of the inlet allows the oxidant supplied to have a component of motion in a desired direction.

In a preferred embodiment, the longitudinal axis of the cylindrical inlet makes an acute angle with the cylinder axis of the screw core so that the inlet end of the inlet, at which the oxidant is supplied to the inlet, points partially or completely in the direction of an intake region of the conveying screw to which the coupling unit is attached. Thus, the supplied oxidant receives a component of motion in the conveying direction. This has the advantage that a supplied oxidant cannot easily move toward the filter device in a direction opposite to the conveying direction. If the inlet end of the inlet points only partially in the direction of the intake region of the screw, i.e. the inlet is also inclined in another direction, the oxidant also receives a component of motion in the circumferential direction of the screw tube, preferably the circumferential direction of the screw helix. This may improve mixing with the condensate (the filter residues).

Further preferably, a resistance heater and/or a gas flow heater and/or radiant heater and/or a microwave heater and/or an induction heater and/or a piezoelectric element can be provided as the energy supply unit.

The resistance heater can be realized, for example, in the form of heating coils around the outer wall of the screw tube or a heating sleeve at this location. The temperature at this location can be controlled, for example, by means of a thermocouple attached to the outer wall of the screw tube. Furthermore, radiant heaters can be attached to the inside of the screw tube to heat the screw core and/or the screw helix and/or the filter residues. Furthermore, the screw core and/or the screw helix and/or the filter residues (the latter preferably having a high content of metal (powder)) can also be heated by microwaves or by means of induction. Alternatively or in addition to heating the conveying screw and/or the filter residues, the gas that is supplied can also be heated, for example in the form of a gas flow heater. A piezoelectric element arranged in the reaction space can also be used to initiate an oxidation reaction. A combination of several of the listed energy supply units is also readily possible.

Further preferably, the at least one inlet can be formed as a gas-permeable porous area in the wall of the reaction chamber.

A gas-permeable porous area in the wall of the reaction chamber can be realized, for example, by a part of the wall consisting of a metal fleece, metal grid or a sintered element. This allows the oxidant to be supplied via a larger surface area, thus allowing the oxidant to better spread in the reaction space.

Advantageously, the gas-permeable porous sections are implemented by providing inserts in the wall of the reaction chamber that can preferably be replaced, each insert having a gas-permeable porous area that replaces the wall of the reaction chamber.

Further preferably, the coupling unit can be configured as a gas lock.

In this context, a gas lock is characterized by a lock chamber having at least two closures which can be closed alternately or simultaneously and which are gas-tight in the closed state. The presence of a gas lock makes it possible to provide for separation of the gas atmospheres in the filter device and in the passivation device, so that the risk of oxidants from the passivation device entering the filter device is minimized.

Preferably, the energy supply unit has a heating device at the inlet for heating the oxidant.

The heating device can, for example, be arranged on an optionally provided supply pipe at the inlet, in particular if a gas containing the oxidant is supplied via the inlet. In any case, heating the supplied oxidant close to the inlet, i.e. immediately before it enters the reaction unit, has the advantage that thermal insulation of the supply pipe is not required, as would be required if the heated oxidant were transported up from a greater distance.

The heating elements can be, for example, resistance heaters (heating coils, etc.), preferably on the outside of the supply pipe, or also an induction heater which, in the case of a supply pipe made of metal, indirectly heats the gas that is supplied. It would also be possible to arrange a number of radiant heaters on an outer wall of the supply pipe that is transparent to radiation.

Further preferably, the energy supply unit has a heating device on a wall of the reaction unit.

The heating elements can be, for example, resistance heaters (heating coils, etc.), preferably on the outside of the reaction unit, or also an induction heater, which, in the case of a wall of the reaction unit that is made of metal, indirectly heats the gas that is supplied. It would also be possible to arrange a number of radiant heaters inside the reaction unit or on a, preferably radiation-transparent, outer wall of the reaction unit. Preferably, the heating elements should be arranged in such a way that heating of the filter residue particles and/or the oxidant as efficient as possible is enabled where the oxidation process is to take place.

Further preferably, a wall of the reaction unit is thermally insulated.

In this case, the wall itself can be made of a thermally insulating material or the wall can be covered from the outside with a thermally insulating material (e.g. glass wool or mineral wool). It is known to the skilled person that the more completely the wall is covered with a thermally insulating material, the better the thermal insulation.

Further preferably, at least one sensor detecting a pressure and/or a temperature in the reaction unit is provided.

At this point, it should be emphasized that in the present application the entire part of the passivation device present between the coupling unit and the discharge unit is considered. Therefore, a sensor need not necessarily be arranged in the reaction space or the reaction chamber, although this is advantageous, but can also be arranged in supply pipes to the reaction space or the reaction chamber. Controlled by signals output by the sensor, for example, the pressure in the reaction unit can be changed or the amount of an oxidant supplied can be decreased or increased.

Further preferably, the reaction unit has a cylindrical reaction chamber, wherein the height of the cylinder exceeds a predetermined minimum value, and the inlet is arranged in the upper half of a vertical extension of a wall of the reaction chamber such that when a gas comprising an oxidant is introduced into the reaction chamber, the direction of the gas flow has a component in the direction of gravity.

The advantage of a cylindrical reaction chamber becomes important when the cylinder height exceeds a predetermined minimum value. The minimum value is predetermined in such a way that filter residue particles, when falling through the cylinder height, heat up as a result of friction with the gas atmosphere present in the reaction chamber to such an extent that an oxidation reaction is promoted, in particular initiated. The downward component of the gas that is introduced, which contains an oxidant, additionally accelerates the filter residue particles. This means that the cylinder height does not need to be selected to be too large. A minimum value to be specified can be determined, for example, by preliminary tests with filter residues to be passivated. It should also be noted that the mathematical definition of a cylinder is used here, i.e. not only circular cylinders are to be included. However, straight cylinder shapes with a ratio of height to maximum diameter of the base area exceeding the value 3 are preferred.

The advantage of such a passivation device is that filter residue particles, as a result of their heating by friction with the gas present in the reaction chamber, which gas comprises an oxidant, can react with the oxidant in flight/free fall. This enables an effective reaction by facilitating contact of the oxidant to the surface of the filter residue particles.

Further preferably, the inlet is arranged in the region of a bottom of the reaction unit, preferably such that when gas is introduced into the reaction unit via the inlet, filter residues accumulating at the bottom of the reaction unit are swirled up.

An arrangement of the inlet in the region of the bottom of the reaction unit enables a particularly effective swirling, since then the filter residue particles at the bottom of the reaction unit can be imparted a component of motion against the force of gravity particularly well. For particularly good swirling, the gas is supplied at a flow velocity that is greater than or equal to 30 m/s and/or less than or equal to 300 m/s.

The swirling of the filter residues can promote an oxidation of the filter residues, since an access of the oxidant to the surfaces of the filter residue particles, i.e. in particular the condensate particles, is facilitated, in other words, a larger part of the surface can be oxidized.

A system according to the invention for passivating filter residues of a filter device arranged in a process gas circuit of an additive manufacturing apparatus comprises:

a passivation device according to the invention and a filter device suitable for removing particles from a process gas stream flowing through an additive manufacturing apparatus, wherein the filter device comprises a filter residue collection area to which the passivation device is couplable.

Here, a filter residue collection area can be a region in the filter device in which filter residue particles accumulate, in particular after a cleaning process of a filter element in the filter device. Generally, a filter residue collection area will be located in the lower region of a filter device (near its bottom), since collection can then be accomplished solely by utilizing the force of gravity acting on the filter residue particles. Therefore, the passivation device is also preferably coupled to the filter device in the bottom region of the filter device.

Preferably, the filter residue collection area can taper towards the location where the passivation device is coupled.

Preferably, a pre-filter or particle separator, preferably a cyclone for separating particles whose diameter exceeds a predetermined value, from the process gas stream, is arranged in the system upstream of the filter device.

The use of the pre-filter prevents excessively large residue particles, e.g. powder particles of the building material whirled up by the process gas stream in the build chamber of the additive manufacturing apparatus, from entering the passivation device coupled to the filter device. Alternatively, pre-filtering can also take place near the filter residue collection area, i.e. near the location where the passivation device is coupled to the filter device. Preferably, filter residue particles having an average diameter exceeding 1 μm, more preferably 500 nm, even more preferably 100 nm, are segregated by the pre-filter and thereby prevented from entering the passivation device.

An additive manufacturing apparatus according to the invention comprises a system for passivating filter residues according to the invention.

A machine park according to the invention comprises a plurality of additive manufacturing apparatuses, and at least one system for passivating filter residues according to the invention, wherein each system for passivating filter residues is associated with at least two additive manufacturing apparatuses, and wherein the at least one system for passivating filter residues is configured to passivate the filter residues of the at least two additive manufacturing apparatuses assigned to it.

By assigning at least two additive manufacturing apparatuses to a system for passivating filter residues, the system can operate particularly efficiently. In particular, a filter device is then also associated with at least two additive manufacturing apparatuses and a process gas circuit comprises the respective build chambers of the at least two additive manufacturing apparatuses.

According to the invention, a passivation device is used for passivating filter residues of a filter device arranged in a process gas circuit of an additive manufacturing apparatus.

By using a passivation device according to the invention, the process gas circuit, in particular the process gas flow through the additive manufacturing apparatus, is not impaired or disturbed during recirculation operation. Rather, filter residues from the filter device are supplied to the passivation device either during the filter cleanings that take place anyway or even while the process gas flows through the filter device.

A method according to the invention for passivating filter residues of a filter device arranged in a process gas circuit of an additive manufacturing apparatus comprises the following steps:
introducing the filter residues from the filter device into a reaction unit by means of a coupling unit that can be coupled to the filter device,
closing the reaction unit with respect to the filter device,
supplying an oxidant into the reaction unit via an inlet,
effecting a reaction between the filter residues and the oxidant in the reaction unit by means of an energy supply unit, and
opening a discharge unit for discharging the passivated filter residues from the reaction unit.

Introducing filter residues into the reaction unit by means of the coupling unit is understood here as creating a connection between the filter device and the reaction unit that is continuous for filter residues. For example, the filter residues can enter the reaction unit using gravity or with the aid of a portioning unit mentioned further above. Preferably, the coupling unit is coupled to the lower side of the filter device.

By closing the reaction unit with respect to the filter device, it is meant that the passage for filter residues in the coupling unit is closed after the introduction of filter residues into the reaction unit. It is understood that before and during the introduction of filter residues into the reaction unit and during the supply of the oxidant, the discharge unit should also be closed in order to prevent discharge of non-passivated filter residues into the collection container and, on the other hand, to prevent an uncontrolled entry of oxidants (in particular oxygen) through the discharge unit into the reaction unit.

The term “effecting a reaction” is meant to imply that a reaction between the filter residues and the oxidant is set in motion (initiated), or is intensified or accelerated, by means of energy supply.

Further preferably, the filter residues are introduced using a portioning device.

Further preferably, prior to the introduction of the filter residues from the filter device, an inert gas is supplied to the reaction unit, preferably via the inlet.

Such a purging process of the reaction unit with an inert gas can in particular prevent oxidant from entering the process gas circuit when the coupling device is opened the next time for the next passivation process.

Further preferably, a gas having the same gas composition as the process gas is supplied to the reaction unit, preferably via the inlet, prior to a further introduction of filter residues into the reaction unit.

By means of a purging process with a gas having the same gas composition as the process gas, an impairment of the process gas atmosphere in the additive manufacturing apparatus during the next opening of the coupling device for the next passivation process can be prevented.

Further preferably, the filter residues in the reaction unit are swirled up by means of gas supply during the reaction between the filter residues and the oxidant.

Basically, what matters is to promote the reaction, so preferably the filter residues are swirled up during the entire period in which oxidation of filter residues is possible in the reaction unit. For example, whirling up can be coupled to the duration of the closure of the coupling unit and of the closure of the discharge unit, i.e., whirled up for as long as the coupling unit and discharge unit are closed. Further preferably, a minimum duration of whirling up can be made dependent on the degree of oxidation of the filter residues and their material composition. Such a minimum duration can be determined in advance in tests and/or a simulation.

Swirling up the filter residues can promote oxidation of the filter residues, since access of the oxidant to the surfaces of the filter residue particles, i.e. in particular the condensate particles, is facilitated, in other words, a larger part of the surface can be oxidized.

Preferably, the method is carried out using a passivation unit according to the invention.

Provided that a passivation unit is used, if the reaction unit is an extruder screw or conveying screw, there may be situations where closure of the discharge unit is not necessary during the introduction of filter residues into the reaction unit and during the supply of the oxidant.

Further preferably, the reaction unit has an extruder screw or conveying screw whose direction of rotation and/or speed of rotation is altered during the reaction between the filter residues and the oxidant. In doing so, the rotational speed is preferably greater than or equal to 0.5 rpm and/or less than or equal to 100 rpm, even more preferably greater than or equal to 1 rpm and/or less than or equal to 5 rpm.

If the reaction unit is an extruder screw, then by changing the direction of rotation in the same way as when the filter residues are swirled up by means of a gas flow, it can be caused that an access of the oxidant to the surfaces of the filter residue particles, i.e. in particular the condensate particles, is facilitated and thus the oxidation reaction is promoted.

Further preferably, in the method, the conveying screw can be formed as a reaction chamber and the conveying screw can comprise a substantially cylindrical screw core surrounded by a screw helix, and a substantially cylindrical screw tube provided as a wall of the reaction chamber.

In a particularly preferred embodiment, pulsed conveying is used, i.e. the rotation of the screw core and of the screw helix is interrupted at times. In this case, energy can continue to be supplied to the reaction space by means of the energy supply unit during the interruptions. In other words, the energy supply unit can, but need not, also be operated in pulsed mode. Preferably, the total time period during which the screw conveys and the total time period during which the energy supply unit supplies energy overlap by at least 80%. Further, the direction of rotation of the screw can also be changed at times, for example to increase the reaction time of the filter residue in the conveying screw with the oxidant. Such an increase in reaction time can also be achieved by the interruptions in the pulsed operation of the screw.

Further preferably, by means of the energy supply unit, the screw tube and/or the screw helix and/or the screw core and/or the filter residues are heated and thus are brought to a temperature of at least 50° C., preferably at least 60° C., and/or at most 1000° C., preferably at most 600° C., particularly preferably at most 300° C.

To monitor the temperature in the reaction space, a number of thermocouples or temperature sensors can be attached to the outside of the screw tube. However, pyrometric measurement of the temperature of the screw core and/or of the filter residues, for example, would also be conceivable.

Further preferably, the reaction between the filter residues and the oxidant is effected by supplying a gas containing the oxidant, which gas has been brought to a temperature of at least 50° C., preferably at least 60° C., and/or at most 1000° C., preferably at most 600° C., particularly preferably at most 300° C.

If a temperature-controlled gas is supplied to effect the oxidation reaction, then the progress of the reaction can be controlled in a simple manner by controlling the amount of the supplied, already pre-tempered, oxidant. In doing so, the temperature level can be chosen, for example, depending on the material, the size and the shape of the condensate particles.

Further preferably, the reaction between the filter residues and the oxidant is effected by supplying a gas containing the oxidant, the gas being supplied via at least one inlet with turbulent free jet, preferably being supplied with a flow velocity of up to 30 m/s, even more preferably with a flow velocity which is greater than or equal to 5 m/s and/or less than or equal to 20 m/s, and even more preferably less than or equal to 15 m/s.

Here, the flow velocity of the gas influences the reaction between oxidant and filter residues in that a higher flow velocity allows better access of the oxidant to the filter residues. On the other hand, excessive turbulence of the filter residues is undesirable if the flow velocity is too high.

It should be mentioned that in the case of gas supply via a porous surface, a supply with creeping laminar flow can also function, so in this particular case it can also fall below the specified lower limit of 5 m/s.

If a gas stream is split to be supplied to the reaction space inside the screw tube via several inlets (e.g., several oxidation chambers), then care should be taken to ensure that the specified minimum flow velocity is not fallen below at any of the inlets.

Further preferably, in the method an oxygen-containing gas is supplied that has an oxygen content greater than or equal to 0 vol %, preferably greater than or equal to 5 vol %, more preferably greater than or equal to 10 vol %, and/or less than or equal to 21 vol %, preferably less than or equal to 15 vol %, particularaly preferably less than or equal to 8 vol %.

Oxygen is suitable as an oxidant for this very reason because it is available at a reasonable price and control of the amount of oxidant added works well by controlling the propotion of oxygen in a gas supplied to the reaction space via an inlet. The amount of oxygen supplied can be used to control the passivation reaction well. For example, the amount of oxygen supplied or the proportion of oxygen in the gas supplied can be controlled as a function of the temperature detected by a temperature sensor in the reaction space. In particular, a temperature rise in the reaction space can be limited by reducing the oxygen content.

Further preferably, the method is carried out until a combustion number of the passivated filter residues is less than 3 and/or a minimum ignition energy exceeds 10 mJ, preferably exceeds 30 mJ, particularly preferably the passivated filter residues are not explosive.

The combustion number (can be determined according to VDI 2263-1) and the minimum ignition energy (can be determined according to EN 13821) are good parameters which can be used to estimate the extent to which passivation has taken place. The objective here is to passivate the filter residues sufficiently so that they are no longer reactive during normal handling, which is the case due to the specified ranges for the combustion number and the minimum ignition energy.

If it is determined that the passivation is still insufficient for a material present, the passivation process can preferably be modified such that the energy supplied by the energy supply unit is increased, e.g., the temperature in the reaction space is increased and/or the dwelling time of the material to be passivated in the reaction space is increased, e.g., the rotational speed of the conveying screw is reduced or its direction of rotation is temporarily reversed and/or an oxygen partial pressure and/or a supplied oxidant quantity is increased.

In a further preferred approach, as an alternative or in addition to the aforementioned change in process parameters, device parameters of the passivation device can also be altered in order to increase the dwelling time of the filter residues in the reaction space. If, for example, a conveying screw is to serve as the reaction space, it is possible (especially if a certain material is to be passivated) to specifically design its geometry in such a way that the dwelling time in the reaction space is increased (e.g., by increasing the length of the screw and/or reducing the pitch of a flight).

Further preferably, the method is performed after the end of a cleaning process or during a cleaning process of a filter element in the filter device. Preferably 30 s, more preferably 1 minute even more preferably 2 minutes, still more preferably 5 minutes, still more preferably 10 minutes after the end of a cleaning process.

Further preferably, a passivation process follows an immediately consecutive number of cleaning processes.

Here, the number of cleaning processes can be 2, 3, 5 or 10.

Further preferably, filter residues that are free of inerting substances are introduced from the filter device into the reaction unit.

Here, inerting substances can be, for example, mineral powders in the order of 1 to 20 μm. Preferably, only those substances are regarded here as inerting substances which are always not yet in gaseous form at the maximum temperatures occurring during a cleaning process, e.g. lime or glass powder or expanded glass granules. By the further development of the invention, it is possible to completely dispense with inerting substances during the cleaning process, which otherwise have a large quantity share in the filter residues. At least, it becomes possible to significantly reduce the proportion of inerting substances. As a result, the amount of filter residues to be disposed of shrinks considerably.

Further features and expediencies of the invention will be apparent from the description of exemplary embodiments with reference to the accompanying drawings.

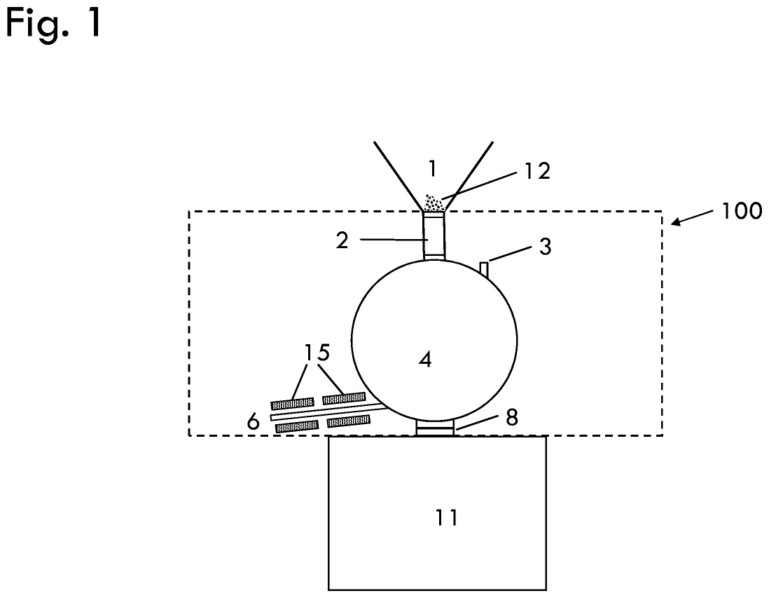

FIG. 1 schematically depicts a passivation device according to a first embodiment.

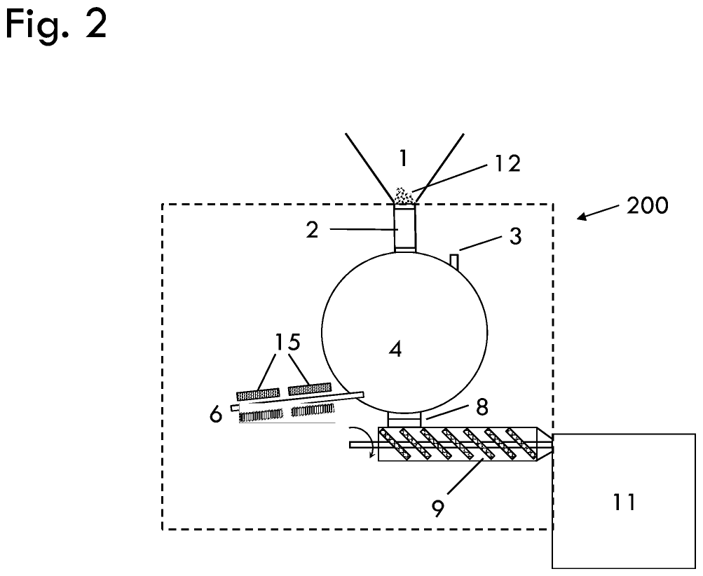

FIG. 2 schematically depicts a passivation device according to a second embodiment.

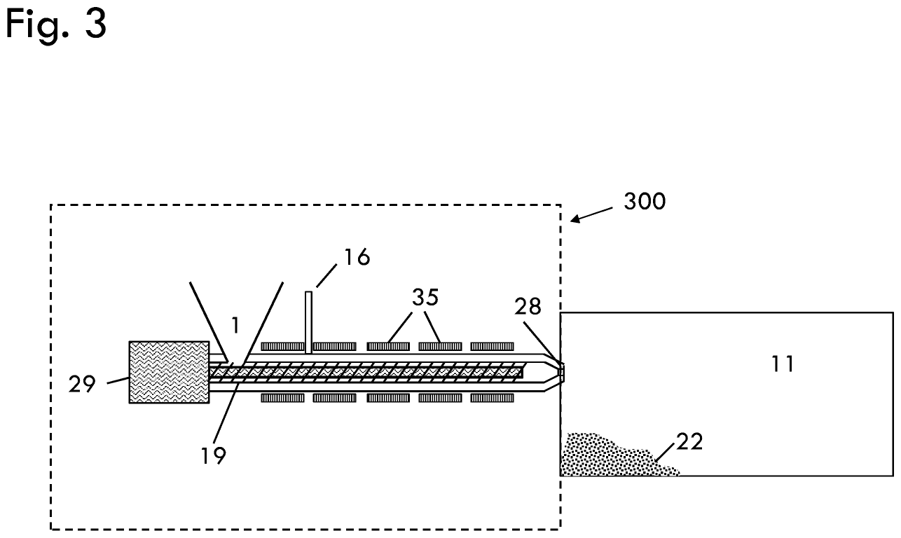

FIG. 3 schematically depicts a passivation device according to a third embodiment.

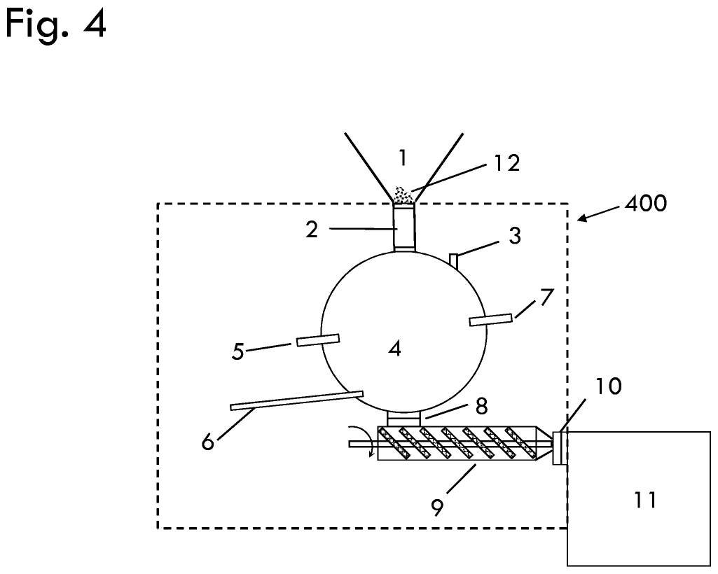

FIG. 4 schematically depicts a passivation device according to a fourth embodiment.

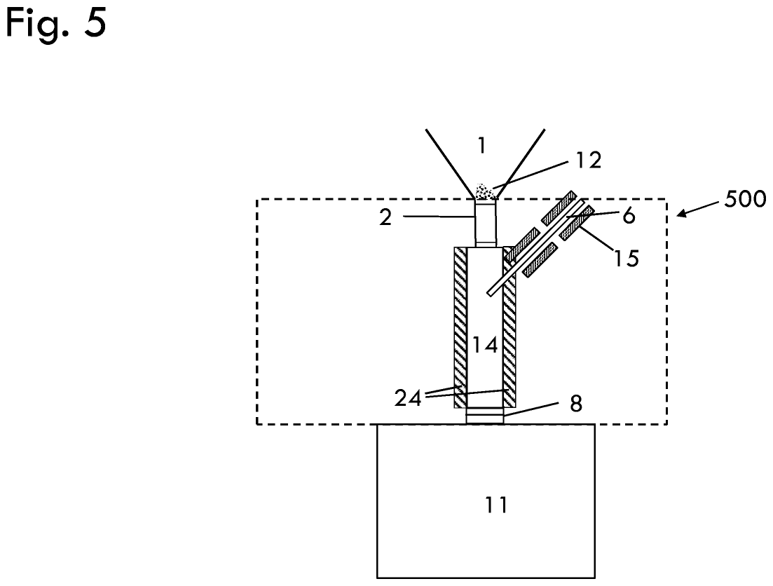

FIG. 5 schematically depicts a passivation device according to a fifth embodiment.

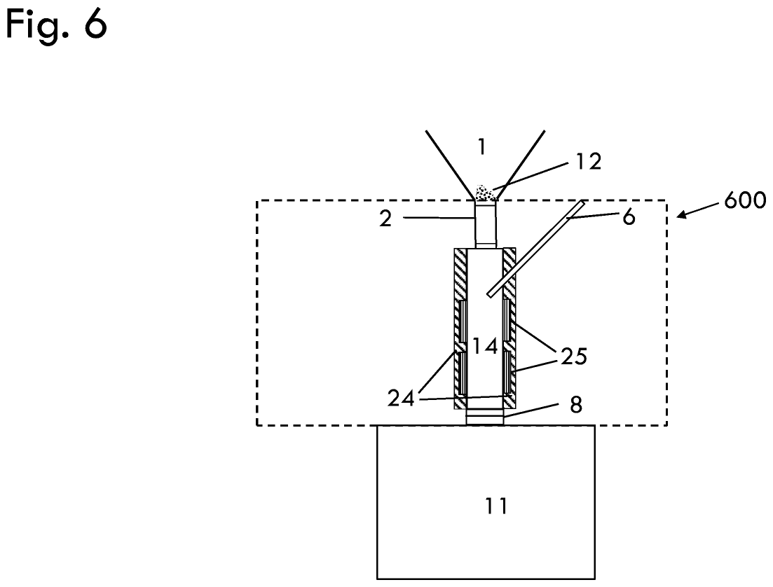

FIG. 6 schematically depicts a passivation device according to a sixth embodiment.

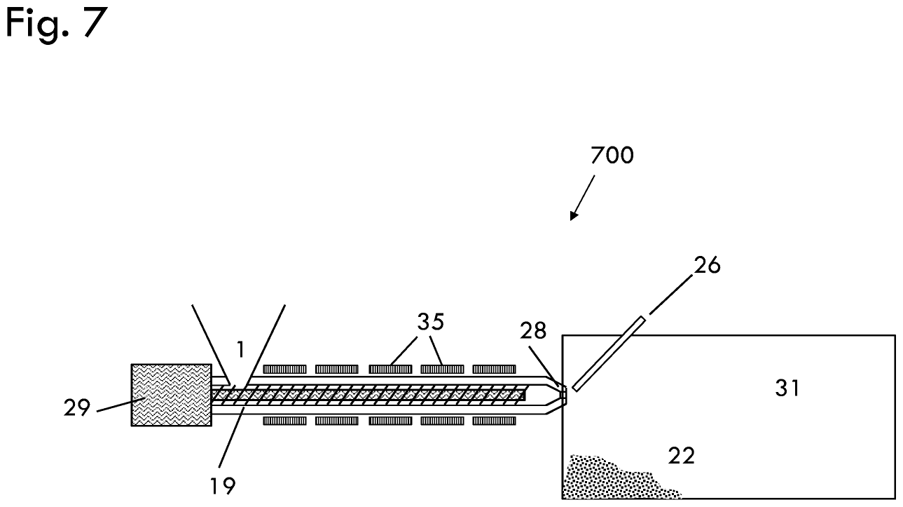

FIG. 7 schematically depicts a passivation device according to a seventh embodiment.

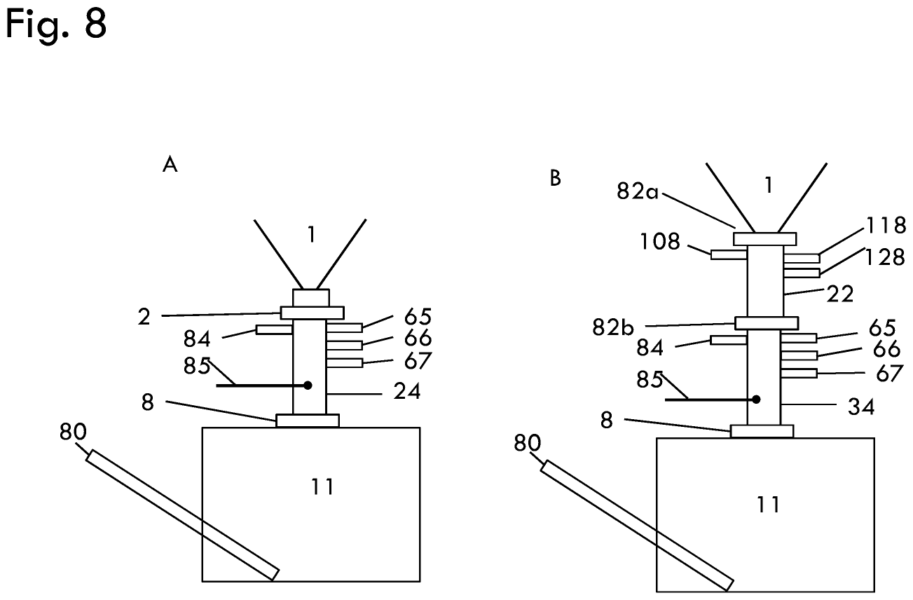

FIG. 8 schematically depicts a passivation device according to an eighth embodiment.

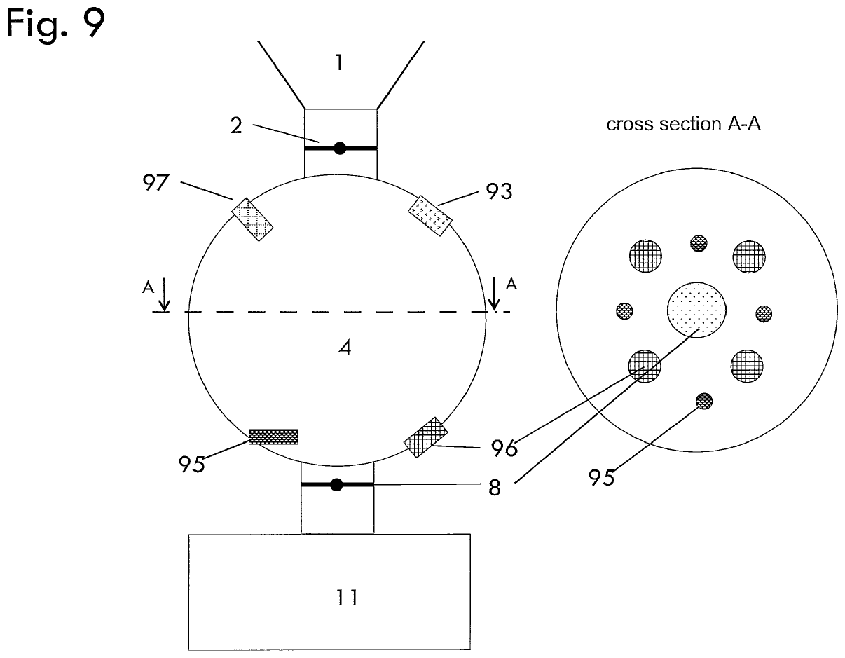

FIG. 9 schematically depicts a passivation device according to a ninth embodiment.

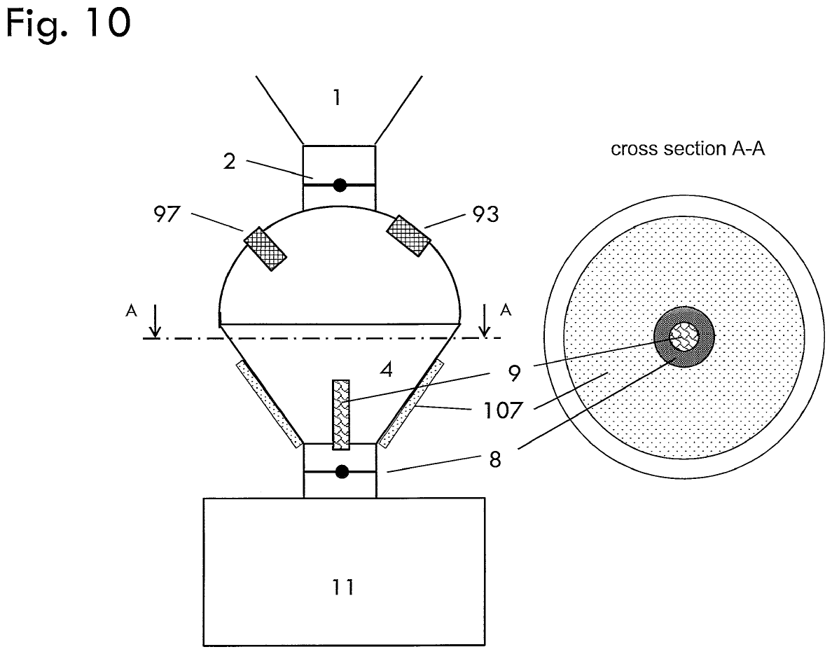

FIG. 10 schematically depicts a passivation device according to a tenth embodiment.

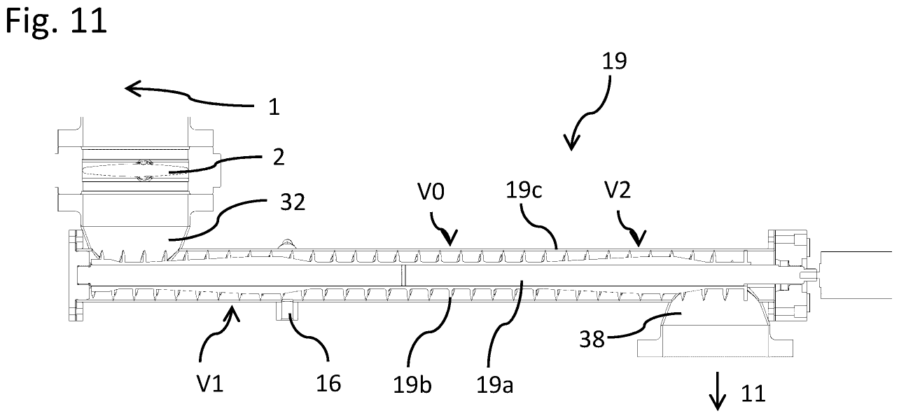

FIG. 11 schematically depicts a passivation device according to an eleventh embodiment.

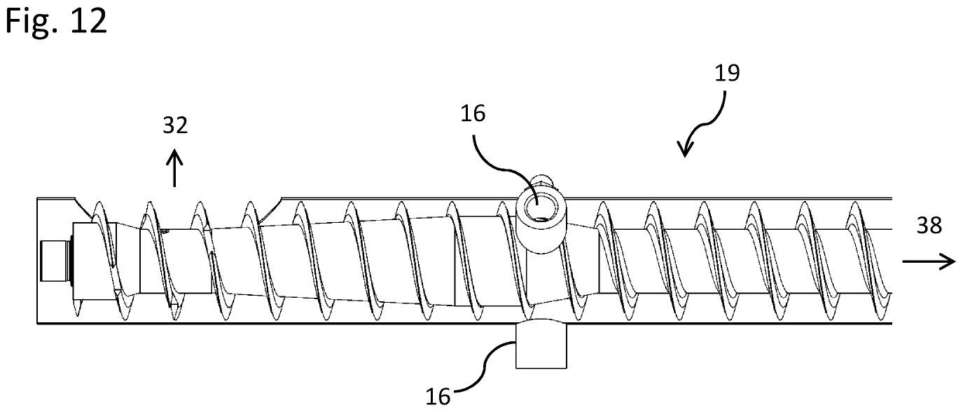

FIG. 12 schematically depicts a particular embodiment of the inlets on a passivation device according to an eleventh embodiment.

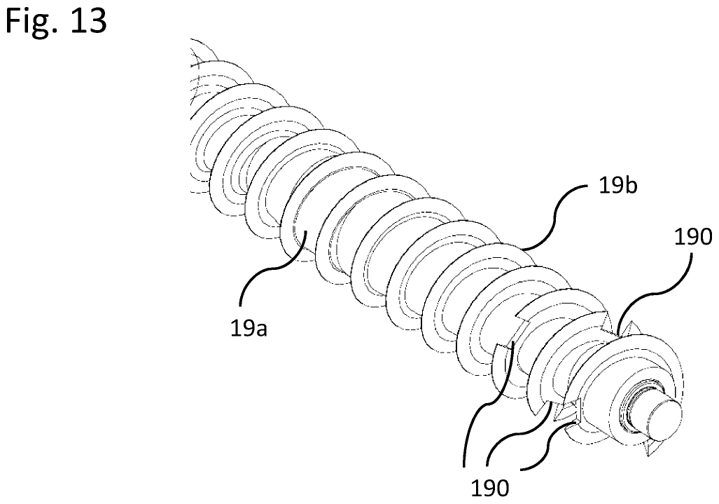

FIG. 13 schematically depicts a particular embodiment of the screw helix on a passivation device according to an eleventh embodiment.

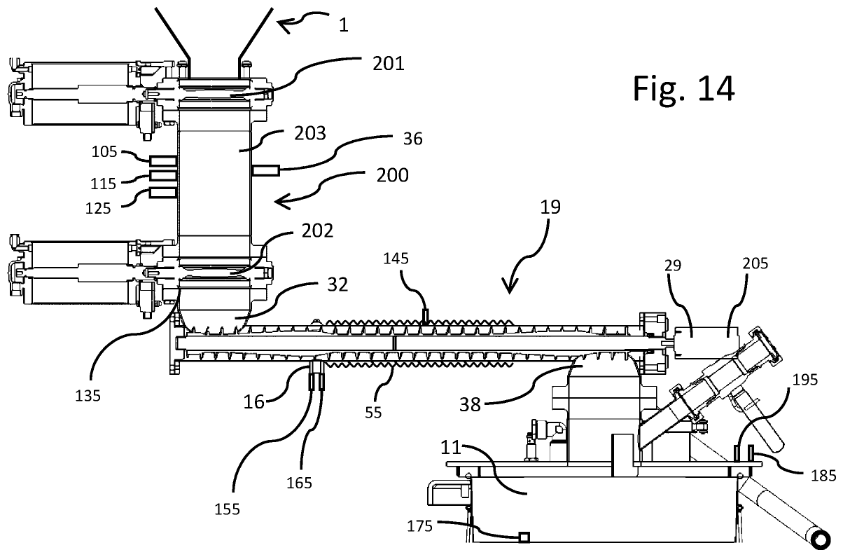

FIG. 14 shows an embodiment of the coupling unit as a gas lock in combination with the eleventh embodiment.

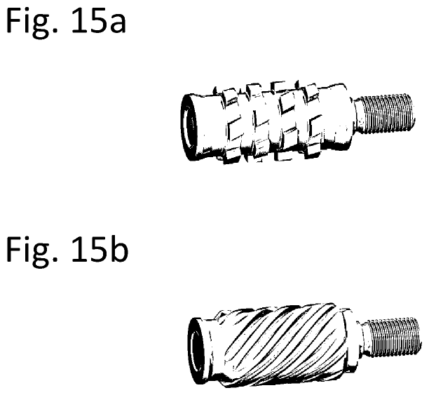

FIG. 15 shows examples of mixing elements that can serve as a model for a section of the screw helix designed as a mixing element.

In the following description of exemplary embodiments of the invention, the structure and operating principle of an additive manufacturing apparatus are not described in detail, as they are described in the prior art, for example in EP 2 978 589 B1.

In the following it is referred to a filter device 1 which is used to remove particles from a process gas stream used in the additive manufacturing apparatus. For this purpose, the filter device 1 is located in a closed process gas circuit, wherein the process gas is preferably passed over the building plane, i.e., the surface of a building material layer on which the electromagnetic radiation or particle radiation impinges to melt the building material at locations corresponding to the cross-section of the object to be manufactured in the building plane. Furthermore, details of the filter device are not described in detail in the following description. The skilled person is familiar with the basic design of a filter device. Here, with regard to the filter device, it is only relevant that the process gas flows through it and that it contains a filter element on which particles contained in the process gas deposit. Furthermore, it is also assumed that the filter device 1 has a discharge region at which the particles filtered out of the process gas stream can be received as filter residues by the passivation device, for example after or during a cleaning process of the filter element as described in DE 10 2014 207 160 A1.

### First Embodiment

The passivation device 100 shown in FIG. 1 according to a first embodiment is attached to the aforementioned filter device 1 in such a way that filter residues, hereinafter also referred to simply as particles, can enter the passivation device 100 from the particle collection area of the filter device 1. In other words, the passivation device 100 is attached to the filter device 1 in the vicinity of the particle collection area of the filter device 1. In FIG. 1, by way of example, particles 12 remaining in the filter element collect at the bottom of the filter device 1 where the passivation device 100 is coupled. In order to facilitate particle collection or particle provisioning, the particle collection area in the filter device 1 is funnel-shaped, which also slows down the discharge of particles.

It should be mentioned that in particular very small particles (e.g. metal condensate) have a high tendency to react, so that for reasons of efficiency in preferred configurations of the first exemplary embodiment only particles up to a certain size are provided for the passivation device 100, for example by separating out larger particles by means of a cyclone separator provided upstream of the filter device, in which cyclone separator a separation between large and small particles takes place. For example, a sieve can be selected such that the maximum size of particles provided to the passivation device 100 is 100 nm, preferably 50 nm.

The passivation device 100 is coupled to the filter device 1 on the particle supply side by means of a coupling unit or lock 2. The lock 2 is a closure (slotted shutter, iris diaphragm, flat slide gate, swing gate, rotary valve, chamber lock, a segmental closure, or the like) which can prevent an exchange of material and gas between the filter device 1 and the passivation device 100. Preferably, the lock 2 in its closed state is capable of ensuring a pre-defined maximum pressure difference between the filter device 1 and the passivation device 100. In other words, the lock 2 is gas-tight up to a pre-defined value of a differential pressure.

Preferably, the lock 2 further comprises a portioning device (not shown) by means of which defined quantities of particles can be supplied to the passivation device 100. In other words, preferably the maximum amount of particles supplied to the passivation device 100 when the lock 2 is opened is limited by means of a portioning device.

A discharge unit or outlet lock 8 is provided at the outlet side of the passivation device 100. This is a closing mechanism which in an opened state allows passivated particles to exit into a collecting container 11. Preferably, the outlet lock 8 is capable of sealing the passivation device 100 in a gas-tight manner with respect to the environment of the passivation device 100 and/or the collecting container 11. Particularly preferably, the outlet lock 8 is capable of maintaining a pre-defined differential pressure with respect to the environment of the passivation device 100 and/or the collecting container 11.

According to the first embodiment, the particles from the filter device 1, hereinafter also referred to as condensate, are passivated by subjecting them to a controlled oxidation. For this purpose, the passivation device 100 comprises a reaction chamber 4 that is formed from a temperature-resistant material. For example, the wall is made of steel or a nickel-base alloy (e.g., Inconel) and is optionally provided on the inside with a coating that impairs or prevents a reaction between the particles and the wall. In order to be able to withstand an increase in pressure inside the reaction chamber 4 possibly occurring during the passivation process, the wall thickness of the reaction chamber is not selected to be too small and is, for example, in the range of 5 to 30 mm for steel, preferably about 10 mm.

Furthermore, the passivation device 100 comprises an inlet 6, for example in the form of a supply pipe, via which an oxidant can be supplied to the interior of the reaction chamber 4. The oxidant can be supplied in gaseous form in the form of air, oxygen or a mixture of air/compressed air and inert gas (e.g. nitrogen or argon). According to the first embodiment, a gas already preheated to a certain temperature is supplied to the reaction chamber 4 via the inlet 6. For example, heating elements 15 can be attached to the supply pipe for preheating. These can be, for example, resistance heaters (heating coils, etc.) or also an induction heater which, in the case of a supply pipe made of metal, indirectly heats the gas supplied. Depending on the nature of the particles (the metal condensate), an oxidation reaction can be brought about with different temperature of the supplied gas. Merely by way of example, the supplied gas can be an oxygen/nitrogen mixture with 10% oxygen content (vol %), which is heated to about 500° C., preferably 300° C. A value between 0 and 21 vol %, preferably 3-10 vol %, even more preferably 6 to 7 vol %, is possible for the oxygen content. Temperatures between 0° C. and 1000° C. are possible.

Preferably, the gas is supplied via the inlet 6 at high pressure and high flow velocity in order to whirl up the condensate particles collecting at the bottom of the reaction chamber and thereby cause a better mixing of oxidant and particles. It should be emphasized that heating of the supplied gas via the inlet 6 need not necessarily be accomplished by means of heating elements attached to the supply pipe, but heating can also be provided in other ways, in which the hot gas is then supplied (e.g., via a thermally insulated supply pipe) to the reaction chamber 4.

Since during the oxidation reaction, depending on the course of the reaction, an excess pressure or underpressure can occur in the reaction chamber 4 relative to the environment of the passivation device 100, the filter device 1 or the collection container 11, the reaction chamber 4 preferably has a compensation valve 3 which can provide for pressure compensation relative to the environment, the filter device or the collection container.

Optionally, the passivation device 100 is detachable from the filter device 1 so that the passivation reaction does not need to take place in the flanged-on state, but can take place at another location. However, especially when the condensate accumulating in the filter element is passivated (oxidized) in portions, it is convenient to operate the passivation device 100 in a state in which it is attached to the filter device 1 (with the lock 2 closed).

An exemplary operation of the passivation device 100 can be such that, as mentioned above, a dose (predefined maximum amount) of the particles accumulated/provided in the filter element is supplied to the passivation device 100 at regular intervals. To supply a predefined amount of particles or condensate, the lock 2 is opened so that particles can enter the reaction chamber 4. Subsequently, a gas comprising an oxidant is supplied to the reaction chamber 4 via the inlet 6. Since the supplied gas has been heated to a high temperature, oxidation can proceed sufficiently quickly depending on a selected oxygen concentration. After a certain waiting time, which is an empirical value determined by preliminary tests, or after an observed increase in pressure and/or temperature in the reaction chamber 4, the passivated condensate, including any accompanying substances that may still be present, can then fall into the collection container 11 by opening the lock 8. The collection container 11 can then be separated from the passivation device 100 after a plurality of passivation operations for disposal or further processing of the passivated material.

After removing the passivated particles from the reaction chamber 4, the reaction chamber 4 can be flooded with inert gas (preferably of the same gas composition as the process gas atmosphere) via the inlet 6 prior to receiving another batch (another dose of particles) from the filter device.

The oxidation process described can proceed more effectively if the inlet 6 is located near the bottom of the reaction chamber 4 so that when the supplied gas containing an oxidant enters, condensate accumulating at the bottom of the reaction chamber 4 is swirled up and oxidized airborne.

### Second Embodiment

The second embodiment of the invention is very similar to the first embodiment, and therefore only the differences with respect to the first embodiment are described below. All of the possible variations of the invention mentioned with respect to the first embodiment apply equally to the second embodiment. The second embodiment differs from the first embodiment in that the lock is not located directly between the reaction chamber 4 and the collection container 11. Rather, a conveying device 9 (for example, a conveying screw or extruder screw) is arranged between the lock 8 and the collection container 11. This conveying device 9 can compress the passivated material before it enters the collection container 11. As a result, the collection container 11 does not need to be changed so often and a greater number of passivation processes/oxidation processes can lie between the replacement processes of the collection container. Furthermore, the use of the conveying device 9 allows more freedom in the choice of the installation site of the collection container 11. As a further example of a conveying device, pneumatic conveying in a pipe could be considered.

### Third Embodiment

The third embodiment differs from the first and second embodiments in that the passivation of the particles or the condensate does not take place in a reaction chamber, but in a conveying screw or extruder screw. In the passivation device 300 according to the third embodiment shown in FIG. 3, the particles from the filter device 1 pass directly into the region of the conveying screw, wherein optionally the region of the conveying screw 19 can be separated from the filter device 1 by a lock which is not shown and which, as in the first and second embodiments, is preferably configured to be gas-tight and pressure-tight. Preferably, in doing so, the particles are supplied to the conveying screw from above, i.e. by utilizing gravity. This facilitates the supply, especially if the flowability of the particles is impaired, i.e. they adhere to each other. Under certain circumstances, it is useful to ensure better passage of the particles at the outlet of the filter device 1 or at the inlet of the conveying screw 19 by means of a vibration device.

By means of the drive motor 29, the screw 19 is set in rotation, by which material is transported from the intake area near the filter device 1 towards the collection container 11. In doing so, the rotational speed is preferably greater than or equal to 0.5 rpm and/or less than or equal to 100 rpm, even more preferably greater than or equal to 1 rpm and/or less than or equal to 5 rpm.

Preferably, gravity is also used when discharging the condensate from the screw, i.e. a respective outlet into the collection container is then not located horizontally at the end of the screw, as shown in FIG. 3, but is then arranged on the underside of the screw.

Via an inlet 16, an oxidant in solid, liquid or gas form, for example oxygen or an oxygen-enriched inert gas, can be added to the condensate conveyed by the screw. For example, a gas mixture consisting of inert gas and compressed air can be supplied.

To bring about a controlled oxidation, the screw is surrounded by heating elements 35 which heat the condensate-gas mixture, the oxidation rate being adjusted via the temperature and the oxygen concentration. In this type of passivation, care should be taken to ensure that the temperature rise due to the oxidation reaction is not too great in order to avoid damage to the screw. During the oxidation reaction, the material (condensate or particles) is transported further towards the collection container 11 and in the course of this is compacted, for example by the conveying screw having a lower flight depth and/or modified flight depth near the collection container 11 than near the filter device 1. Preferably, this increases the bulk density of the material by a factor of between 2 and 10, typically by a factor of 3. Furthermore, an optional nozzle 28 at the outlet of the extruder screw 19 can provide additional compaction of the passivated condensate 22 discharged into the collection container 11. In a modification of the third embodiment, the conveying screw does not rotate continuously in one direction, but by means of the drive 29 the direction of rotation is changed intermittently, thereby providing for mechanical agitation of the condensate in the conveying screw 19, which enables a better oxidation reaction.

Essentially, the passivation device 300 allows for a continuous supply of particles from the filter device 1 into the passivation device 300. The configuration of the screw thread may ensure that the amount of particles supplied is limited. Further, the inlet 16 through which an oxidant is supplied is spaced sufficiently far from the outlet of the filter device 1 to prevent the oxidant from entering the filter device 1 (e.g., 100 mm). However, it is of course possible to provide for a more controlled passivation by providing a lock 2 containing a portioning device.

Optionally, the material (particles or condensate) is passivated in the extruder screw 19 not by means of a controlled oxidation, but by adding via the inlet 16 a binder enclosing the condensate. This binder can be, for example, a plastic granulate or setting/solidifying materials (e.g. liquid glass). Heating in the conveying screw may then cause, for example, the plastic granulate to melt and as a result enclose the metal condensate. The passivated material 22 could then be used, for example, as a material for other industries that have a use for plastic encased metal.

Furthermore, it is also possible to combine the third embodiment with the first or second embodiment, for example by performing a two-stage passivation, first in the reaction chamber 4 and then in the extruder screw 19. It should also be noted at this point that the passivation according to the invention can also be performed in a multi-stage manner by connecting the passivation devices described in the various embodiments of the invention in series in any desired manner. In such a multi-stage passivation, passivation can be particularly gentle in the case of highly reactive materials. For example, only small amounts of an oxidant can be added in each of the individual passivation devices connected in series.

### Fourth Embodiment

FIG. 4 shows a fourth embodiment of the invention, which is similar to the second embodiment, and therefore the following description focuses on the differences with respect to the second embodiment. In the passivation device 400 according to the fourth embodiment, in order to start the oxidation reaction after the oxidant is added to the reaction chamber 4, an ignition element 5 shown in FIG. 4 and located in the reaction chamber is ignited to introduce additional energy. The ignition element 5 can be a glow wire, a glow plug, a spark plug or a piezoelectric element. Once the reaction has started, the oxidation reaction then progresses on its own as reaction heat that is generated keeps the reaction going. For better control of the reaction, a sensor 7 consisting of a pressure and/or temperature sensor is attached to/in the reaction chamber 4. Controlled by signals output by the sensor 7, the compensation valve 3 can be actuated, for example, to change the pressure in the reaction chamber 4 or else to decrease or increase the supply of the oxidant.

In this embodiment, the supplied gaseous oxidant does not necessarily need to be preheated, even though in principle additional preheating of the oxidant is possible. Furthermore, the oxidant can also be supplied in solid or liquid form via the inlet 6.

Preferably, regardless of whether the oxidant is supplied in gaseous form, a gas stream is supplied to the reaction chamber 4 via the inlet 6 in order to whirl up condensate particles deposited at the bottom of the reaction chamber and thus to provide for a better reaction between the oxidant and the condensate particles. The inlet 6 is therefore preferably located near the bottom of the reaction chamber 4. The progress of the passivation process is as described in connection with the first embodiment. In the case of an oxidant supplied in gaseous form, the oxygen content of the supplied gas should be adjusted between 0 and 21 vol %, preferably between 3 and 10 vol %, more preferably between 5 and 8 vol %. It is to be expected that the oxidation reaction taking place will create a negative pressure in the reaction chamber 4, as oxygen is removed from the gas atmosphere. However, provided that the reaction proceeds at a high rate, the gas will heat up greatly and expand, resulting in an excess pressure. Preferably, therefore, the oxygen concentration of the supplied gas is changed to control the reaction.

Preferably, the reaction chamber is thermally insulated by surrounding it with a non-combustible material, such as glass wool or mineral wool. It should also be mentioned that the compensation valve 3 should preferably have a sinter filter or a sinter candle to prevent condensate particles from leaving the system/the reaction chamber 4 during pressure equalization.

### Fifth Embodiment

The fifth embodiment is similar to the first embodiment. The following description therefore focuses on the differences compared to the first embodiment.

As can be seen from FIG. 5, in the fifth embodiment the reaction chamber 14 has a cylinder shape. Furthermore, it can be seen that an inlet 6 is not arranged at the bottom of the reaction chamber 14, but in the upper half thereof, and in such a way that the supplied gas has a component of motion directed against the direction of gravity. The differences described have the following effect:

The cylindrical reaction chamber 14 has a larger vertical extension than the reaction chamber 4. For example, the length/height of the cylinder has at least three times the value of its maximum diameter perpendicular to its longitudinal axis. Due to the large height of fall given as a result of the height of the cylinder, oxidation in mid-air can be caused during the descent of the filter residue particles. The gas supplied through the inlet 6 can further increase the mixing and thus the reaction rate of the condensate particles as a result of the direction of flow of the gas. A reduction of the supplied thermal energy is possible if, as shown in FIG. 5, the reaction chamber 14 is further provided with a thermal insulation, for example non-combustible glass wool or mineral wool. A passivation device 500 according to the fifth embodiment is operated in the same manner as the passivation devices of the other embodiments. In particular, the passivation device according to the fifth embodiment can in addition also be provided with a conveying device 9, as is the case with the second embodiment.

### Sixth Embodiment

A sixth embodiment of the invention shown in FIG. 6 is very similar to the fifth embodiment. As distinguished from the fifth embodiment, the gas containing an oxidant, which is supplied via the inlet 6, does not necessarily have to be heated via heating elements attached to the supply pipe. According to the sixth embodiment, heating elements 25 are attached to the outside of the reaction chamber, which heating elements again can be resistance heaters or induction heaters. Of course, it is also possible to use both heating of the reaction chamber and a preheated supplied gas with an oxidant, which corresponds to a combination of the fifth and sixth embodiments.

### Seventh Embodiment

The seventh embodiment is very similar to the third embodiment, so the following description focuses on the differences from the third embodiment. In a passivation device 700 according to a seventh embodiment, the oxidant is not supplied to the condensate particles in the region of the conveying screw 9, but only at the end of the screw/conveying device 9 after the nozzle 28. The passivation device according to the seventh embodiment therefore has an inlet 26 at the end of the conveying screw directed towards the collection container 31. In doing so, a gas jet comprising an oxidant is directed via the inlet 26 onto the metal condensate leaving the screw in order to provide for oxidation of the metal condensate in this region.

As a result of the compaction of the condensate particles at the outlet of the screw, a reaction tendency is reduced so that an oxidation reaction can take place in a controlled manner. Nevertheless, in the seventh embodiment, the collection container 31 can be provided with a wall that is temperature stable and pressure stable, similar as it was specified for the reaction chamber 4. Preferably, in the seventh embodiment, the gas comprising an oxidant should be supplied in a preheated state, although corresponding heating elements are not shown in FIG. 7.

Similar to the third embodiment, according to the seventh embodiment, oxidation (passivation) and compression of the condensate particles can take place simultaneously. Likewise, both continuous and portion-wise (batch-wise) operation can be performed.

As in the third embodiment, a binder can alternatively or additionally be supplied to the condensate particles via an additional inlet on the screw 9 not shown in the figure (similar to the inlet with reference sign 16 in FIG. 3).

### Eighth Embodiment

The eighth embodiment is explained with reference to FIGS. 8A and 8B. In the variant of the eighth embodiment shown in FIG. 8A, an exemplary sequence of the passivation process is as follows:

A certain period of time (approx. 10 minutes) before a cleaning operation of a filter element in the filter device, the reaction chamber 24 (e.g. a temperature-stable cylinder with an inner diameter of approx. 15 cm) is flooded with N2 or argon via the valves 66 or 67. During this process, the outlet valve 84 is open. The reaction chamber should preferably have about 2.5 times the volume of the discharged filter cake to be expected during the cleaning process. In the time period prior to a cleaning operation, preferably about 10 times the volume of the reactor space (or of the reaction chamber 24) should be purged with N2 or argon. The gas flow must be sufficient to create a turbulent flow in the reaction chamber.

Shortly before the filter is cleaned, the valves 66 and 67 are closed and the flap 2 is opened. The filter is then cleaned in the filter device 1. A few seconds (e.g. 5 seconds) after the cleaning pressure surge, the flap 2 is closed and compressed air is supplied into the system via the valve 65. At the same time, an energy supply element 85 (piezo element or heating rod) is heated. After 30 minutes, the discharge unit (flap) 8 is opened for about five seconds and the valves 65 and 84 are closed. A vacuum cleaner can then be used to remove the passivated condensate particles/filter residues from the collection container 11 via a suction pipe 80. The reaction chamber is then flooded via valves 66 or 67 with approximately 5 times the chamber volume.

The advantage of this variant of the eighth embodiment is that the separate valves 65, 66 and 67 make it possible to supply gas mixtures to the reaction chamber in a simple manner. Furthermore, this allows, for example, an excessive supply of an oxidant via the valve to be immediately compensated by a supply of inert gas via one of the valves 66 and 67.

A further advantage of this variant of the eighth embodiment results from the compact design of the passivation device, in which a small reaction chamber can be used.

In the variant of the eighth embodiment shown in FIG. 8B an exemplary sequence of the passivation process is as follows:

Prior to cleaning of the filter, the collection lock 88 is flooded via the valves 118 and 128 with 10 times the volume with either N2 or argon with the outlet 10 being open. The valves 108, 118, 128 are closed and flap 82a is opened, the filters are cleaned and the flap 82a is closed. After approx. 5 seconds, flap 82b is opened for approx. 5 seconds and compressed air is introduced via the valve 65 with the outlet 84 open and the energy supply element 85 (piezo element or heating rod) is switched on. After 30 minutes, all valves are closed and the passivated condensate particles/filter residues are discharged via the discharge unit 8 into the collection container 11.

The advantage of the second variant of the eighth embodiment is that the functions of the flap 2 (gas tightness and material tightness) can be allocated to two flaps. While one flap provides for gas tightness, the other flap provides for material tightness. In view of the increased temperatures and pressures possible within the reaction chamber, this means that the requirements on the material for sealing the flaps are no longer as high. The valves 66 and 67 can be omitted depending on the gas tightness of the flap 82b. Since filter residues can be stored temporarily in the collection lock 88, they can be supplied from there in small quantities for a passivation process, for example, via a portioning device.

### Ninth Embodiment

A ninth embodiment of the invention is described with reference to FIG. 9.

The lock 2 and the discharge unit 8 can be configured in the same manner as in the other embodiments. In an exemplary passivation process, the lock 2 is initially open and the discharge unit 8 is closed. Condensate particles/filter residues from the filter device 1 can then fall through the lock 2 into the reaction chamber 4. After each filter cleaning in the filter device 1, the lock 2 is closed. An oxygen-containing gas, for example compressed air, ambient air, pure oxygen or a mixture of oxygen and a protective gas, flows through the condensate particles/filter residues in the reaction chamber 4 via the porous inserts 96 (four inserts are shown in the cross section A-A as an example, but any other number is possible, for example 8 or 16). Pressure equalization is ensured via the gas outlet 93. For this purpose, the valve for the gas outlet (not shown) is opened. Then the energy supply elements 95 (e.g. piezo elements or heating rods) are activated to initiate the oxidation reaction. Four energy supply elements are shown as an example, but any other number is possible, e.g., 8 or 16. After the oxidation reaction is finished, the gas flow through the inlets 96 and the energy supply elements 95 are deactivated again and then, possibly after a waiting period for cooling, the discharge unit 8 is opened. The passivated condensate particles then fall into the collection container 11. The transport of the passivated condensate particles can be assisted by a gas surge via the gas inlets 96. Subsequently, the discharge unit 8 is closed again. A protective gas is introduced into the reactor chamber 4 via the gas inlet 96 until a sufficiently inert atmosphere (e.g. O2 <2%) is reached. The valve at the gas outlet 93 is then closed and the lock 2 is opened again. The process is repeated with the next filter cleaning and at the end of the process.

In the sensor unit/monitoring unit 97, critical process variables are measured, such as the temperature and the pressure, especially during the reaction; as well as the oxygen content, especially before the start of the reaction as well as during the final inerting of the reaction chamber at the end of a passivation step.

The advantage of the ninth embodiment is that by using sintered filters at the gas inlet, a uniform inflow of the gas can be ensured. Furthermore, the (symmetrical) arrangement of the gas inlets allows the gas to be supplied uniformly to the entire reaction space inside the reaction chamber.

### Tenth Embodiment

A tenth embodiment of the invention is described with reference to FIG. 10.

The lock 2 and the discharge unit 8 can be configured in the same manner as in the other embodiments. In an exemplary passivation process, the lock 2 is initially open and the discharge unit 8 is closed. Condensate particles/filter residues from the filter device 1 can then fall through the lock 2 into the reaction chamber 4. After each filter cleaning in the filter device 1, the lock 2 is closed. An oxygen-containing gas, for example compressed air, ambient air, pure oxygen or a mixture of oxygen and a protective gas, flows through the condensate particles/filter residues in the reaction chamber 4 via the porous funnel 107. Pressure compensation is ensured via the gas outlet 93. For this purpose, the valve for the gas outlet (not shown) is opened. Then the energy supply elements 95 (e.g. piezo elements or heating rods) are activated to initiate the oxidation reaction. After the oxidation reaction is finished, the gas flow through the porous funnel 107 and the energy supply elements 95 are deactivated again and then, possibly after a waiting period for cooling, the discharge unit 8 is opened. The passivated condensate particles then fall into the collection container 11. The transport of the passivated condensate particles can be assisted by a gas surge via the porous funnel 107. Subsequently, the discharge unit 8 is closed again. Protective gas is introduced into the reactor chamber 4 via the gas inlet 96 until a sufficiently inert atmosphere (e.g. O2 <2%) is reached. The valve at the gas outlet 93 is then closed and the lock 2 is opened again. The process is repeated with the next filter cleaning and at the end of the process.

In the sensor unit/monitoring unit 97, critical process variables are measured, such as the temperature and the pressure, especially during the reaction; as well as the oxygen content, especially before the start of the reaction as well as during the final inerting of the reaction chamber at the end of a passivation step. Alternatively to the arrangement of the energy supply elements 95 as in the ninth embodiment, one or more heating elements can be arranged on the wall of the funnel.

The advantage of the tenth embodiment is similar to that of the ninth embodiment. By using the porous funnel 107 for supplying the gas, a uniform inflow of the gas can be provided, wherein the gas can flow in uniformly from all directions. It should be noted that the funnel 107 and the reaction chamber can also have a different shape. For example, a circular cylindrical funnel whose entire lateral wall is porous is conceivable. The porosity of the funnel can be achieved by forming it in the same way as a sintered filter, so to say as a monolithic, large-area sintered filter.

### Eleventh Embodiment

FIG. 11 shows an eleventh embodiment that is very similar to the third embodiment and also comprises a screw. In the passivation device shown in FIG. 11, a screw 19 serves as a reaction chamber surrounding a reaction space. For this purpose, the screw shown in FIG. 11 has a cylindrical screw core 19a to which a screw helix 19b is attached, both of which are accommodated in a screw tube 19c which is to be regarded as the wall of the reaction chamber. Here, the diameter of the screw core 19a is typically between 20 and 30 mm, the outer diameter (in the radial direction) of the screw helix 19b is typically between 30 and 40 mm, the flight depth is typically between 3 and 6 mm, and the flight pitch angle is typically between 15 and 25 degrees. The flight pitch is typically a value between 80% and 100% of the outer diameter of the screw helix. The length of the screw is typically at a value greater than or equal to 25 cm and less than or equal to 50 cm.

Although the radial dimensions of the screw are constant along the path from the intake area near the filter device 1 to the outlet near the collection container 11, the screw geometry can also be varied along the path to thereby create different zones where either compaction is predominant or oxidation is predominant. This is shown by way of example in FIG. 11. In FIG. 11, elements corresponding to those in FIG. 3 are provided with the same reference signs, wherein in particular the intake area near the coupling unit 2 is provided with the reference sign 32 and the discharge unit near the collection container 11 is provided with the reference sign 38.

In particular, the screw 19 shown in FIG. 11 has two compression zones V1 and V2, as well as an oxidation zone V0 arranged between them. As can be seen from FIG. 11, compaction of the material is provided in the compression zones V1 and V2 by means of a reduced flight depth as compared to the oxidation zone. As can be seen, a variation of the flight depth is brought about by means of a change in the core diameter.

It is also conceivable that, differing from FIG. 11, only one compression zone or more than two compression zones are present and/or more than one oxidation zone is present.

In FIG. 11, the first compression zone V1 is arranged close to the intake area 32 of the screw 19, preferably directly adjacent to the intake area 32. Such an arrangement is advantageous, since the compacted condensate constitutes a barrier for the oxidant and prevents or at least significantly reduces a backflow of the oxidant into the filter device 1. Furthermore, the second compression zone V2 is arranged close to the outlet 38. As a result, compressed condensate is supplied to the collection container 11, which takes up less volume in the collection container 11, thereby extending the service life of the collection container 11.

As shown in FIG. 11, the inlet 16 via which an oxidant is supplied should be arranged in the region of the oxidation zone, preferably at its beginning (when viewed in the conveying direction). In the case of a plurality of oxidation zones, an inlet 16 associated with each of these oxidation zones would have to be provided accordingly. However, this is not meant to exclude the oxidant being supplied to an oxidation zone via a plurality of inlets; this is also possible and is shown in particular in FIG. 12.

By providing a plurality of oxidation zones, oxidation can be performed in multiple stages. For example, the material is first pre-oxidized in the first oxidation zone and further oxidized after being transported to the second oxidation zone. For example, a larger amount of oxidant (e.g., oxygen) can be supplied to the second oxidation zone for this purpose. In particular, the first oxidation zone can also merge into the second oxidation zone, in which case an inlet for an oxygen-containing gas or an oxygen-containing gas mixture is arranged at each oxidation zone.

It is advantageous if the inlet 16 is arranged at the lower end (in the vertical direction) of the screw 19, as shown in FIG. 11. Such an arrangement ensures that a gas supplied via the inlet 16 results in a slight swirling of the condensate tending to accumulate (as a result of gravity) in the lower region of the screw, which promotes oxidation of the condensate. Alternatively or additionally, an inlet 16 for a gas containing the oxidant can be arranged above the screw. Such an arrangement has the advantage that the inlet 16 arranged above cannot be clogged so quickly by condensate, which preferably accumulates in the lower region of the screw as a result of gravity. In order to nevertheless ensure good mixing of the condensate with the oxidant when the inlet 16 is arranged above the screw, the gas should preferably be supplied at such a high velocity that sufficient access of the oxygen to the condensate occurs even if the condensate settles in the lower region of the screw, when the gas flow is incident from above. A high velocity can be generated, for example, by choosing a sufficiently small diameter of the inlet 16 (e.g., between 3 and 5 mm). In other words, the inlets 16 should preferably be realized as gas nozzles.

If a plurality of inlets 16 surround the screw in the circumferential direction (for example, three inlets spaced at 120° from each other), then the oxidant can be supplied uniformly from all sides and homogeneous oxidation can thus be achieved.

Exemplarily, a gas mixture is supplied via the inlet 16 with a volume flow rate that is greater than or equal to 0.5 l/min, preferably greater than or equal to 5 l/m in and/or less than or equal to 30 l/min, preferably less than or equal to 10 l/min. The value to be set here depends on the rotational speed and the dimensions of the conveying screw as well as the oxygen content of the gas supplied. The latter should also contain an inert gas in addition to oxygen, for example a mixture of oxygen and nitrogen is possible or a mixture of an inert gas (e.g. argon, nitrogen) and air. The total oxygen content in the gas is typically between 5 and 10 vol %, preferably between 8 and 10 vol %. Depending on the application, the total oxygen content during the progress of the passivation process can also be in the range between 0 and 21 vol. %. In particular, the total oxygen content is selected as a function of the passivation reaction taking place in the reaction space, i.e., in particular as a function of the temperature in the reaction space.

In particular, as shown in FIG. 12, the inlet 16 can have the shape of a connecting piece or a pipe. This need not be perpendicular to the longitudinal axis of the cylindrical screw, as shown in the figure. Rather, the connecting piece or pipe can also form an acute angle with the longitudinal axis of the screw. This allows the gas supplied to have a component of motion in the conveying direction or else in the circumferential direction of the screw. While a component of motion in the conveying direction counteracts a backflow of the gas in the direction of the coupling unit/filter device, a component of motion in the circumferential direction can lead to better mixing of the gas with the filter residues. Alternatively, an inlet can also be implemented by means of a porous section of the wall of the screw tube 19c or a porous insert in the wall of the screw tube. For this purpose, the wall section or insert can be configured as a microporous element, such as a gas-permeable sintered member, a metal fleece or metal mesh.

As far as the design of the screw helix 19b (i.e., the screw thread) is concerned, it can be of a uniform design. However, it is also possible to vary the geometry of the screw helix along the conveying direction, i.e. in particular to provide recesses in the flanks of the screw helix 19b or to vary the shape of the flanks of the screw helix 19b and/or the flank angle. This can ensure better mixing of the condensate. For this purpose,

FIG. 13 shows an example in which notches or recesses 190 are present in the screw helix 19b. It makes sense to provide recesses 190 in the intake area 32 in particular, since this allows the condensate to be drawn in better there. As far as the shape of the flanks and the flank angle are concerned, it is advantageous to provide a sharp edge (small end face) on the outside of the screw helix 19b (in the radial direction), since oxidation reactions and the deposition of condensate in this delicate area are then reduced as a result of the smaller contact area.

In particular, a section of the screw helix 19b can also have the shape of a mixing element, as is known in the field of extruder screws. For this purpose, FIG. 15 shows two examples of mixer (elements) such as those offered by Groche Technik GmbH in 32689 Kalletal (https://www.groche.com/produkte/dynamische-mischer). The spiral mixing element shown in FIG. 15b can be used to achieve a splitting effect, whereby agglomerates of filter residues can be broken up in the screw. The diamond mixing element shown in FIG. 15a has advantages when agglomerates are no longer present and a surface enlargement and rearrangement of particles is to be achieved. The sections of the screw (in the direction of the cylinder axis) where a portion of the screw helix 19b has the shape of a mixing element are referred to in this application as mixing zones. In particular, it is convenient to provide a mixing zone having a diamond mixing element downstream of a mixing zone with a spiral mixing element. In the material supplied to the diamond mixing element, agglomerates have then already been removed by the spiral mixing element.

Of course, combined forms of the elements shown in FIGS. 15a and 15b are also possible.

The screw 19 is preferably made of a material with high temperature resistance, for example IN718. In particular, the screw can be manufactured by means of an additive manufacturing process as a whole or in several segments which can be put or screwed together.

As can be seen, it is possible to combine the embodiments described above, provided they are not obviously mutually exclusive. This also applies to combinations which are not explicitly mentioned in the text.

In particular, the invention makes it possible to reduce the amount of inerting substances in the filter device or to dispense with them entirely.

In the following, optional modification possibilities are described which are applicable in connection with all embodiments.

With the exception of the embodiment variant shown in FIG. 8B, a simple closure is proposed as an implementation option for the coupling unit 2 between the filter device and the reaction chamber in all embodiments. The same applies to the discharge unit 8 between the passivation device and the collection container 11. Of course, the coupling unit 2 and/or the discharge unit 8 can also be designed as a gas lock with two mutually operable closures. This is explained below with reference to FIG. 14.

FIG. 14 shows a coupling unit 200 with a lock chamber 203 arranged between an upper closure 201 and a lower closure 202. In the example of FIG. 14, the lock 200 is arranged between the intake 32 of a conveying screw 19 serving as a passivation device and a filter device 1. The lock 200 is operated, for example, in such a way that an inert gas atmosphere is first produced in the lock chamber with the upper closure 201 closed and the lower closure 202 closed, by supplying an inert gas (e.g. nitrogen or argon) via a lock gas inlet 36. An oxygen sensor 105 can be used to measure the residual oxygen content of the gas atmosphere within the lock chamber 203. As soon as the oxygen sensor 105 detects a drop in the oxygen content below a predetermined minimum level, which depends on the reactivity of the condensate, the upper closure 201 is opened after a cleaning process while the lower closure 202 remains closed, so that condensate/filter residue material can pass from the filter device 1 into the lock chamber 203. Subsequently, the upper closure 201 is closed and then the lower closure 202 is opened (after an inert gas atmosphere has also been provided in the conveying screw 19) to supply the condensate/filter residue material to the passivation device. Before further material is supplied from the filter device 1 into the lock chamber 203, the lower closure 202 is closed and an inert gas atmosphere is again established in the lock chamber. Subsequently, the upper closure 201 can be opened in order to supply new material to the lock chamber 203 again.

In all embodiments, the use of the gas lock 200 can reliably prevent oxidant from passing from the passivation device into the filter device. If the gas lock 200 is arranged between the filter device and the passivation device, an uncontrolled entry of condensate/filter residue material into the passivation device can be counteracted at the same time. In other words, the amount of condensate and the point in time at which it is supplied to the passivation device can be better controlled. In particular, the material is then supplied to the passivation device in batch mode, i.e., in doses, rather than continuously.

In this case, the volume of the lock chamber 203 depends on the amount of condensate/filter residue material that can/should be supplied to the passivation device as a maximum for a passivation process and/or on the amount of condensate/filter residue material that is typically produced during a cleaning process. The determination of this amount is based on the type of additive manufacturing device used, in particular the process parameters during additive manufacturing and/or the filter parameters, e.g. the filter area or else the number of filter devices connected to the lock 200 and/or the intended time duration between two filter cleaning processes/passivation processes. The longer this time duration is, the more material will be produced during a cleaning process. This may result in a required volume of the lock chamber 203, which is typically greater than or equal to 1 liter and less than or equal to 15 liters. An exemplary value for the volume in common additive processes using a metal-containing building material is between 3 to 4 liters.

A gas lock 200 with an alternately operable lock inlet and lock outlet can also be combined with a portioning device (for example, implementable by means of a rotary feeder or scraper feeder).

With regard to the dimensioning of the doses to be supplied to the passivation device for a passivation process, the size of a dose can preferably be determined taking into account a number of boundary conditions: for example, the maximum value of the amount of energy released during passivation and/or the pressure stability of the reaction chamber (including its closures and seals). Since the amount of energy released depends on the type and nature of the material, it is preferable, for safety reasons, to base the calculation of the size of a dose on that material whose reaction with the oxidant is particularly exothermic (e.g. titanium material).

An exemplary sequence of a passivation process by means of the passivation device according to the eleventh embodiment is described below with reference to FIG. 14. It should be noted that the coupling unit does not necessarily have to be a lock 200 as shown in FIG. 14, but also a simple closure 2 if the process sequence is adapted accordingly.

During the course of a manufacturing process in the additive manufacturing device, the upper closure 201 of the lock 200 is normally open while the lower closure 202 is closed. In other words, passage of material and gas through the coupling unit is not possible. During a cleaning of the filter device (e.g., every 10 machine operating hours), new material is then supplied into the lock chamber 203.

As soon as the cleaning process is finished or a filling level sensor 115 in the lock chamber 203 detects that a certain filling level has been exceeded, the upper closure 201 is closed and the lower closure 202 is opened so that the cleaned material/filter condensate (e.g. 2-3 liters of aluminum condensate) can enter the intake area 32 of the conveying screw 19. If it is desired to prevent oxidant from entering the lock chamber 203, then optionally the lower closure 202 can now be closed. Now the heating coil 55 is switched on to heat the screw tube (e.g. to about 300° C.). Then the screw drive 29 is activated to start conveying through the screw and the oxidant is supplied via the inlet 16. In doing so, the screw rotates at about 2 rpm, which, with the values for the dimensions of the screw mentioned further above, results in a mass flow of about 1 to 1.5 g/min. Observance of the conveying speed is monitored by a rotary speed sensor 205. In this example, the oxidant is a nitrogen-oxygen mixture with 10 vol % oxygen content, which is supplied with the aid of the flow rate sensor 155 at a volume flow rate of about 8 l/min via the inlet 16. For safety reasons, the oxygen content of the supplied gas is monitored by a gas inlet sensor 165.

Screw conveying is stopped and the supply of further oxidant is interrupted as soon as a pre-set time period has elapsed or a sensor not shown in the intake area of the screw notifies that the condensate material in the intake area of the screw has been completely conveyed away. Another stopping criterion is the detection of the exceeding of a maximum filling level in the collection container 11 by a collection container filling level sensor 195. Furthermore, for safety reasons, the supply of further oxidant is stopped if the flow rate sensor 155, the gas inlet sensor 165, a temperature sensor 145 attached to the screw, a temperature sensor 175 attached to the container bottom of the collection container or an oxygen sensor 185 attached to the collection container provides an incorrect or too high value.

The duration of the oxidation treatment of the condensate material in the screw can be controlled by the rotational speed and/or the flight pitch and/or the flight depth and/or the number/period of time of operating times of the screw in which the screw rotates in the opposite direction. In general, the aim is to treat the material until it is no longer reactive during normal handling. Suitable values for the duration of the oxidation treatment/passivation treatment can be determined by a small number of preliminary tests in which different treatment durations are applied and then the combustion number (according to VDI 2263-1) and the minimum ignition energy (according to EN 13821) are determined on the passivated filter residue material. The aim is to achieve a combustion number that is less than 3 or a minimum ignition energy that is greater than 30 mJ.

Finally, it should be mentioned that additional safety can be provided by further temperature sensors, e.g. a lock chamber temperature sensor 125 and an intake temperature sensor 135. Apart from this, it is understood that the skilled person can also dispense with one or more of the sensors mentioned so far in the passivation device according to the eleventh embodiment.

1. A passivation device for passivating filter residues of a filter device arranged in a process gas circuit of an additive manufacturing apparatus, comprising:
a reaction unit having:
an inlet suitable for supplying an oxidant,
a coupling unit adapted to be coupled to the filter device for introducing filter residues into the reaction unit,
a discharge unit suitable for discharging passivated filter residues from the reaction unit, and
an energy supply unit suitable for effecting a reaction between the filter residues and the oxidant in the reaction unit.

2. Passivation device according to claim 1, wherein the coupling unit comprises a portioning unit for limiting the amount of filter residues supplied to the reaction unit to a predefined value.

3. Passivation device according to claim 1, wherein the coupling unit and/or the discharge unit are designed to resist a pressure difference of up to 8 bar, preferably up to 15 bar, in the closed state.

4. Passivation device according to claim 1, wherein the reaction unit comprises a reaction chamber, in the wall of which a pressure compensation valve is arranged.

5. Passivation device according to claim 4, wherein the wall of the reaction chamber is designed to resist a pressure difference of up to 8 bar.

6. Passivation device according to claim 1, wherein the reaction unit is a conveying screw.

7. Passivation device according to claim 6, wherein a direction of rotation of the conveying screw can be switched.

8. Passivation device according to claim 6, wherein the conveying screw is formed as a reaction chamber and the conveying screw comprises a cylindrical screw core surrounded by a screw helix, and a screw tube as a wall of the reaction chamber.

9. Passivation device according to claim 8, wherein at least one of a depth of a flight, a pitch of a flight, a shape of the flanks of the screw helix or a flank angle of the screw helix, vary along the cylinder axis of the screw core.

10. Passivation device according to claim 9, wherein the conveying screw comprises at least one compression zone and at least one oxidation zone, wherein the depth of a flight in the at least one compression zone is smaller than in the at least one oxidation zone.

11. Passivation device according to claim 10, wherein the conveying screw comprises more than one oxidation zone.

12. Passivation device according to claim 9, wherein the conveying screw comprises at least one mixing zone along the cylinder axis of the screw core, in which a section of the conveying screw is designed as a mixing element along the cylinder axis.

13. Passivation device according to claim 9, wherein the inlet is arranged at an oxidation zone near an end of the oxidation zone that is closer to the coupling unit.

14. Passivation device according to claim 8, wherein a plurality of inlets is provided.

15. Passivation device according to claim 11, wherein at least one inlet is arranged at each oxidation zone that is present.

16. Passivation device according to claim 8, wherein a resistance heater and/or a gas flow heater and/or radiant heater and/or a microwave heater and/or an induction heater and/or a piezoelectric element are present as the energy supply unit.

17. Passivation device according to claim 1, wherein at least one inlet is formed as a gas-permeable porous area in the wall of the reaction chamber.

18. Passivation device according to claim 1, wherein the coupling unit is formed as a gas lock.

19. A method for passivating filter residues of a filter device arranged in a process gas circuit of an additive manufacturing apparatus, having the steps:
introducing the filter residues from the filter device into a reaction unit by means of a coupling unit that can be coupled to the filter device,
closing the reaction unit with respect to the filter device,
supplying an oxidant via an inlet into the reaction unit,
effecting a reaction between the filter residues and the oxidant in the reaction unit by means of an energy supply unit, and
opening a discharge unit for discharging the passivated filter residues from the reaction unit.

20. Method according to claim 19, wherein the filter residues are introduced using a portioning device.

21. Method according to claim 19, wherein an inert gas is supplied to the reaction unit before the filter residues are introduced from the filter device.

22. Method according to claim 19, wherein the method is carried out using a passivation device.

23. Method according to claim 22, wherein the reaction unit comprises a conveying screw.

24. Method according to claim 23, wherein a direction of rotation and/or a rotational speed of the conveying screw are altered during the reaction between the filter residues and the oxidant.

25. Method according to claim 23, wherein the conveying screw is formed as a reaction chamber and the conveying screw comprises a substantially cylindrical screw core surrounded by a screw helix, and a substantially cylindrical screw tube as a wall of the reaction chamber.

26. Method according to claim 25, wherein, by means of the energy supply unit, the screw tube and/or the screw helix and/or the screw core and/or the filter residues are heated and thus are brought to a temperature of at least 50° C. and/or at most 1000° C.

27. Method according to claim 19, wherein the reaction between the filter residues and the oxidant is effected by supplying a gas containing the oxidant, which gas has been brought to a temperature of at least 50° C. and/or at most 1000° C.

28. Method according to claim 26, wherein the reaction between the filter residues and the oxidant is effected by supplying a gas containing the oxidant, the gas being supplied via at least one inlet with turbulent free jet, preferably being supplied with a flow velocity up to 30 m/s.

29. Method according to claim 27, wherein an oxygen-containing gas is supplied that has an oxygen content greater than or equal to 0 vol % and/or less than or equal to 21 vol %.

30. Method according to claim 19, wherein the method is carried out until a combustion number of the passivated filter residues is less than 3 and/or a minimum ignition energy exceeds 10 mJ.

31. Method according to claim 19, wherein a passivation process follows an immediately consecutive number of cleaning processes.

32. Method according to claim 19, wherein filter residues are introduced from the filter device into the reaction unit which are free of inerting substances.
